(19) United States
(12) Patent Application Publication
(10) Pub. No.: US 2012/0007501 A1
(43) Pub. Date: Jan. 12, 2012

(54) DISPLAY DEVICE

(75) Inventors: Shinichiro Tamura, Yongin-city (KR); Byoung-Ki Choi, Yongin-city (KR); Myeong-Suk Kim, Yongin-city (KR); Sang-Yeol Kim, Yongin-city (KR); Sung-Hun Lee, Yongin-city (KR)

(73) Assignee: Samsung Mobile Display Co., Ltd., Yongin-city (KR)

(21) Appl. No.: 13/178,326

(22) Filed: Jul. 7, 2011

(30) Foreign Application Priority Data
Jul. 9, 2010 (KR) 10-2010-0066448

(51) Int. Cl. H01J 1/62

(52) U.S. Cl. 313/507

(57) ABSTRACT

A display device is disclosed. The pixels of the display are formed so that a chromaticity range of the red organic emission layer satisfies an NTSC standard if λpr=3.93557E−03 Wr²+1.07200E−01 Wr+6.10199E+02 and λpr=610 nm, a chromaticity range of the green organic emission layer satisfies the NTSC standard if 3.33879E−03 Wg²+3.03246E−02 Wg+5.18496E+02≦λpg≦−5.09468E−03 Wg²+4.45905E−02 Wg+5.37887E+02, 515 nm≦λpg≦540 nm, and Wg<50 nm, a chromaticity range of the blue organic emission layer satisfies the NTSC standard if −2.59294E−03 Wb²+2.59334E−02 Wb+4.64771E+02≦λpb≦−5.24375E−03 Wb²+9.70218E−02 Wb+4.71672E+02, 450 nm≦λpb≦480 nm, and Wb<70 nm, and at least one of the red organic emission layer, the green organic emission layer, and the blue organic emission layer satisfies the NTSC standard.

### CROSS-REFERENCE TO RELATED APPLICATIONS

This application claims priority to and the benefit of Korean Patent Application No. 10-2010-0066448 filed in the Korean Intellectual Property Office on Jul. 9, 2010, the entire contents of which are incorporated herein by reference.

### BACKGROUND

1. Field

The described technology relates generally to a display device, and more particularly, to a flat panel display.

2. Description of the Related Technology

Flat panel displays may employ a variety of technologies including, for example, the following: a liquid crystal display (LCD), a plasma display panel (PDP), an organic light emitting diode (OLED) display, a field effect display (FED), and an electrophoretic display device.

Among them, the organic light emitting diode display includes two electrodes and an organic emission layer positioned between two electrodes, and electrons injected from one electrode and holes injected from the other electrode are coupled with each other on the organic emission layer to form excitons and the excitons emit light while emitting energy.

Whether or not a chromaticity of the organic light emitting diode display satisfies a standard chromaticity range of an NTSC standard or an sRGB standard in a commission International de l'Eclairage chromaticity (CIE) 1931 color coordinate chart or a CIE 1976 color coordinate chart is an evaluation criteria of color reproducibility of the organic light emitting diode display.

Japanese Patent Laid-Open Publication Nos. 2004-127563, 2004-227854, 2009-134906, and 2009-500790 describe contents on the color reproducibility, a peak wavelength and a width of an emission spectrum of the organic light emitting diode display, but a condition and a method which can improve both color reproducibility and luminous efficiency of the organic light emitting diode display by using characteristics of the emission spectrum of the organic emission layer will not be described in detail.

The above information disclosed in this Background section is only for enhancement of understanding of the background of the described technology and therefore it may contain information that does not form the prior art that is already known in this country to a person of ordinary skill in the art.

### SUMMARY OF CERTAIN INVENTIVE ASPECTS

One inventive aspect is a display device. The display device includes a substrate, a plurality of first electrodes formed on the substrate, and a plurality of organic emission layers, each formed on one of the first electrodes, where the organic emission layers are each configured to emit light of one of red, green, and blue colors. The display device also includes a plurality of second electrodes, each formed on one of the organic emission layers, where a chromaticity range of the red organic emission layer satisfies an NTSC standard if λpr=3.93557E−03 Wr²+1.07200E−01 Wr+6.10199E+02 and λpr=610 nm, where a chromaticity range of the green organic emission layer satisfies the NTSC standard if 3.33879E−03 Wg²+3.03246E−02 Wg+5.18496E+02≦λpg≦−5.09468E−03 Wg²+4.45905E−02 Wg+5.37887E+02, 515 nm≦λpg≦540 nm, and Wg<50 nm, where a chromaticity range of the blue organic emission layer satisfies the NTSC standard if −2.59294E−03 Wb²+2.59334E−02 Wb+4.64771E+02≦λpb≦−5.24375E−03 Wb²+9.70218E−02 Wb+4.71672E+02, 450 nm≦λpb≦480 nm, and Wb<70 nm, where λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and where at least one of the red organic emission layer, the green organic emission layer, and the blue organic emission layer satisfies the NTSC standard.

Another inventive aspect is a display device. The display device includes a substrate, a plurality of first electrodes formed on the substrate, and a plurality of organic emission layers, each formed on one of the first electrodes, where the organic emission layers are each configured to emit light of one of red, green, and blue colors. The display device also includes a plurality of second electrodes, each formed on one of the organic emission layers, where a chromaticity range of the red organic emission layer satisfies an NTSC standard if λpr=3.93557E−03 Wr²+1.07200E−01 Wr+6.10199E+02 and λpr=610 nm, where a chromaticity range of the green organic emission layer satisfies the NTSC standard if 3.33879E−03 Wg²+3.03246E−02 Wg+5.18496E+02≦λpg≦−5.09468E−03 Wg²+4.45905E−02 Wg+5.37887E+02, 515 nm≦λpg≦540 nm, and Wg<50 nm, where a chromaticity range of the blue organic emission layer satisfies the NTSC standard and the sRGB standard if −2.59294E−03 Wb²+2.59334E−02 Wb+4.64771E+02≦pb≦−6.83799E−05 Wb³+5.65420E−04 Wb²−8.40121E−02 Wb+4.68232E+02, 460 nm≦λpb≦470 nm, and Wb<40 nm, where λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and where at least one of the red organic emission layer, the green organic emission layer, and the blue organic emission layer satisfies the NTSC standard or the NTSC standard and an sRGB standard.

Another inventive aspect is a display device. The display device includes a substrate, a plurality of first electrodes formed on the substrate, and a plurality of organic emission layers, each formed on one of the first electrodes. The display device also includes a plurality of second electrodes, each formed on one of the organic emission layers, where a chromaticity range of the red organic emission layer satisfies an sRGB standard if λpr=3.72604E−03 Wr²+8.35845E−01 Wr+6.07097E+02 and λpr=605 nm, where a chromaticity range of the green organic emission layer satisfies the sRGB standard if 2.75023E−03 Wg²+9.61132E−03 Wg+5.14566E+02≦λpg≦−3.05147E−03 Wg²+4.10247E−03 Wg+5.52619E+02, 510 nm≦λpg≦555 nm, and Wg<80 nm, where a chromaticity range of the blue organic emission layer satisfies the sRGB standard if −3.68126E−05 Wb³−1.81334E−03 Wb²−2.99417E−03 Wb+4.61104E+02≦λpb≦−6.83799E−05 Wb³+5.65420E−04 Wb²−8.40121E−02 Wb+4.68232E+02, 430 nm≦λpb≦470 nm, and Wb<80 nm, where λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and where at least one of the red organic emission layer, the green organic emission layer, and the blue organic emission layer satisfies the sRGB standard.

Another inventive aspect is a display device. The display device includes a substrate, a plurality of first electrodes formed on the substrate, and a plurality of organic emission layers, each formed on one of the first electrodes. The display device also includes a plurality of second electrodes, each formed on one of the organic emission layers, where a chromaticity range of the red organic emission layer satisfies an sRGB standard if λpr=3.72604E−03 Wr²+8.35845E−01 Wr+6.07097E+02 and λpr=605 nm, where a chromaticity range of the green organic emission layer satisfies the sRGB standard if 2.75023E−03 Wg²+9.61132E−03 Wg+5.14566E+02≦λpg≦−3.05147E−03 Wg²+4.10247E−03 Wg+5.52619E+02, 510 nm≦λpg≦555 nm, and Wg<80 nm, where a chromaticity range of the blue organic emission layer satisfies the NTSC standard and the sRGB standard if −2.59294E-03 Wb²+2.59334E−02 Wb+4.64771E+02≦λpb≦−6.83799E−05 Wb³+5.65420E−04 Wb²-8.40121E−02 Wb+4.68232E+02, 460 nm≦λpb≦470 nm, and Wb<40 nm, where λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and where at least one of the red organic emission layer, the green organic emission layer, and the blue organic emission layer satisfies the sRGB standard or the NTSC standard and the sRGB standard.

### BRIEF DESCRIPTION OF THE DRAWINGS

FIG. 1 is a layout view of an organic light emitting diode display according to a first exemplary embodiment;

FIG. 2 is a cross-sectional view of an organic light emitting diode display taken along line II-II of FIG. 1;

FIG. 3 is a CIE 1931 chromaticity chart showing the relationship between a peak wavelength and a spectrum width of an emission spectrum of an organic light emitting diode display according to a first exemplary embodiment;

FIG. 4 is a CIE 1931 chromaticity chart enlarging and showing the relationship between a peak wavelength and a spectrum width of an emission spectrum of an organic light emitting diode display according to a first exemplary embodiment;

FIG. 5 is a graph illustrating the relationship between a peak wavelength and a spectrum width of a red emission spectrum in the NTSC standard and the sRGB standard shown in Tables 1 and 2;

FIG. 6 is a graph representing a contour figure of luminous efficiency (N) in the graph of FIG. 5;

FIG. 7 is a graph showing the relationship between a spectrum width and a peak wavelength of an emission spectrum of an organic light emitting diode display according to a first exemplary embodiment;

FIG. 8 is a CIE 1931 chromaticity chart enlarging and showing the relationship between a peak wavelength and a spectrum width of an emission spectrum of an organic light emitting diode display according to a second exemplary embodiment;

FIG. 9 is a graph illustrating the relationship between a peak wavelength and a spectrum width of a green emission spectrum in the NTSC standard and the sRGB standard shown in Tables 7 and 8;

FIG. 10 is a graph representing a contour figure of luminous efficiency (N) in the graph of FIG. 9;

FIG. 11 is a graph showing the relationship between a spectrum width and a peak wavelength of an emission spectrum and luminous efficiency of an organic light emitting diode display according to a second exemplary embodiment;

FIG. 12 is a CIE 1931 color chart enlarging and showing the relationship between a peak wavelength and a spectrum width of an emission spectrum of an organic light emitting diode display according to a third exemplary embodiment;

FIG. 13 is a graph illustrating the relationship between a peak wavelength and a spectrum width of a blue emission spectrum in the NTSC standard and the sRGB standard shown in Tables 13 and 14;

FIG. 14 is a graph representing a contour figure of luminous efficiency (N) in the graph of FIG. 13; and

FIG. 15 is a graph illustrating a relationship between a spectrum width and a peak wavelength of an emission spectrum and luminous efficiency of the organic light emitting diode display according to the third exemplary embodiment.

### DETAILED DESCRIPTION OF CERTAIN INVENTIVE EMBODIMENTS

Various aspects and features are described more fully hereinafter with reference to the accompanying drawings, in which exemplary embodiments are shown. As those skilled in the art would realize, the described embodiments may be modified in various different ways, all without departing from the spirit or scope of the present invention.

In addition, the size and thickness of each component shown in the drawings are arbitrarily shown for understanding and ease of description, but the present invention is not limited thereto.

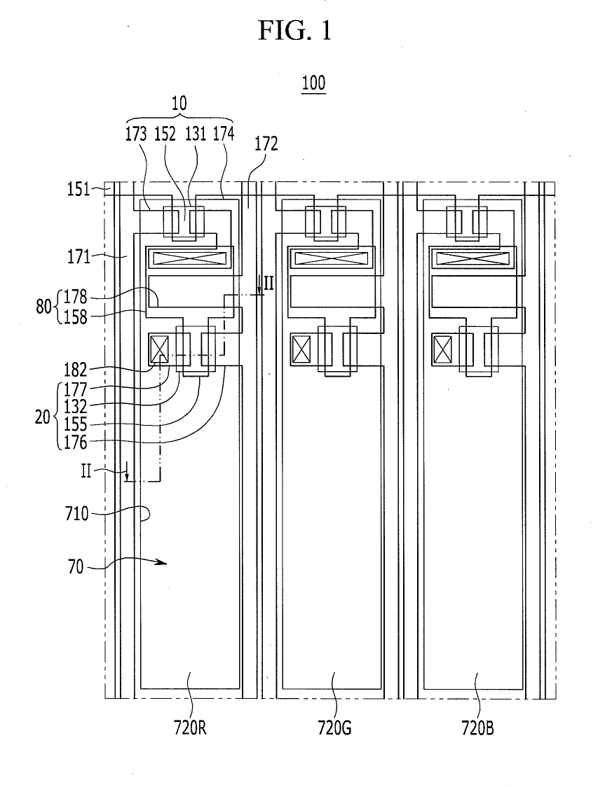

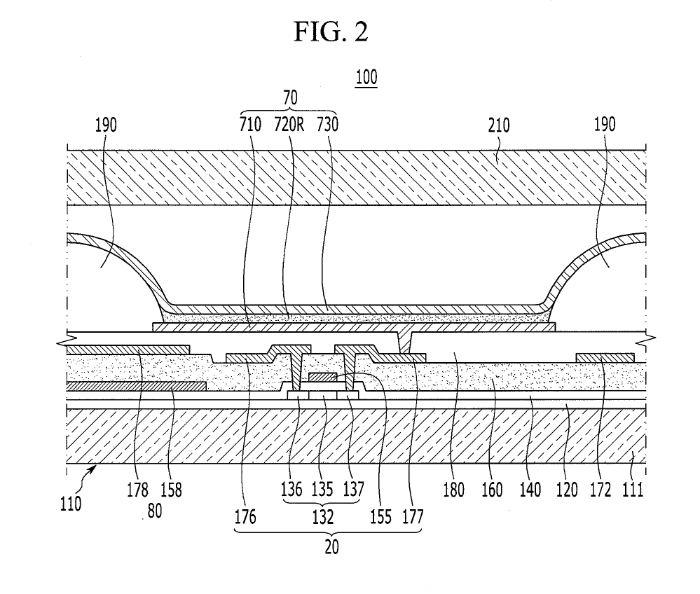

Hereinafter, an organic light emitting diode display according to a first exemplary embodiment will be described in detail with reference to FIGS. 1 and 2.

FIG. 1 is a layout view of an organic light emitting diode display according to a first exemplary embodiment and FIG. 2 is a cross-sectional view of an organic light emitting diode display taken along line of FIG. 1.

As shown in FIGS. 1 and 2, the display panel 110 includes a switching thin film transistor 10, a driving thin film transistor 20, a storage capacitor 80, and an organic light emitting diode 70 formed in each one pixel. In addition, the display substrate 110 further includes a gate line 151 disposed in one direction, and a data line 171 and a common power supply line 172 that insulatively cross the gate line 151. Herein, a boundary of one pixel may be defined by the gate line 151, the data line 171, and the common power supply line 172, but is not limited thereto.

The organic light emitting diode 70 includes a first electrode 710, an organic emission layer 720 formed on the first electrode 710, and a second electrode 730 formed on the organic emission layer 720. Herein, the first electrode 710 is a positive (+) electrode which is a hole injection electrode and the second electrode 730 is a negative (−) electrode which is an electron injection electrode. Holes and electrodes are injected into the organic emission layer 720 from each of the first electrode 710 and the second electrode 730. When excitons generated by combining the injected holes and electrons with each other are transitioned from an excited state to a ground state, light is emitted.

The storage capacitor 80 includes a first storage plate 158 and a second storage plate 178 with an interlayer insulating layer 160 interposed therebetween. Herein, the interlayer insulating layer 160 becomes a dielectric. Capacitance is determined by electric charges stored in the storage capacitor 80 and voltage between both the storage plates 158 and 178.

The switching thin film transistor 10 includes a switching semiconductor layer 131, a switching gate electrode 152, a switching source electrode 173, and a switching drain electrode 174. The driving thin film transistor 20 includes a driving semiconductor layer 132, a driving gate electrode 155, a driving source electrode 176, and a driving drain electrode 177.

The switching thin film transistor 10 is used as a switching element that selects a desired pixel to emit light. The switching gate electrode 152 is connected to the gate line 151. The switching source electrode 173 is connected to the data line 171. The switching drain electrode 174 is disposed spaced apart from the switching source electrode 173 and connected to the first storage plate 158.

The driving thin film transistor 20 applies driving power for allowing the organic emission layer 720 of the organic light emitting diode 70 in the selected pixel to emit light to the first electrode 710. The driving gate electrode 155 is connected to the first storage plate 158. Each of the driving source electrode 176 and the second storage plate 178 is connected to the common power supply line 172. The driving drain electrode 177 is connected to the first electrode 710 of the organic light emitting diode 70 through an electrode contact hole 182.

By this structure, the switching thin film transistor 10 is operated by gate voltage applied to the gate line 151 to serve to transfer data voltage applied to the data line 171 to the driving thin film transistor 20. Voltage equivalent to a difference between common voltage applied to the driving thin film transistor 20 from the common power supply line 172 and the data voltage transmitted from the switching thin film transistor 10 is stored in the storage capacitor 80 and current corresponding to the voltage stored in the storage capacitor 80 flows into the organic light emitting diode 70 through the driving thin film transistor 20 to allow the organic light emitting diode 70 to emit light.

Hereinafter, referring to FIG. 2, the structure of an organic light emitting diode display according to an exemplary embodiment will be described in detail in accordance with a lamination sequence.

A first substrate member 111 forming the display substrate 110 is formed by an insulating substrate that is made of glass, quartz, ceramic, plastic, etc. A buffer layer 120 is formed on the first substrate member 111. The buffer layer 120 serves to prevent impurity elements from being permeated and flatten a surface. The buffer layer 120 may be made of various materials that can perform these roles. The driving semiconductor layer 132 is formed on the buffer layer 120. The driving semiconductor layer 132 is made of a polycrystalline silicon film. Further, the driving semiconductor layer 132 includes a channel region 135 that is not doped with the impurities, and a source region 136 and a drain region 137 that are doped with p+ at both sides of the channel region 135. A gate insulating layer 140 which is made of silicon nitride SiNx or silicon oxide SiO₂ is formed on the driving semiconductor layer 132. A gate wire including the driving gate electrode 155 is formed on the gate insulating layer 140. Further, the gate wire further includes the gate line 151, the first storage plate 158, and other wires. In addition, the driving gate electrode 155 is overlapped with at least a part of the driving semiconductor layer 132, in particular, the channel region 135.

The interlayer insulating layer 160 covering the driving gate electrode 155 is formed on the gate insulating layer 140. The gate insulating layer 140 and the interlayer insulating layer 160 share through-holes for exposing the source region 136 and the drain region 137 of the driving semiconductor layer 132. The interlayer insulating layer 160 is made of a ceramic-based material such as silicon nitride (SiNx) or silicon oxide (SiO₂) like the gate insulating layer 140.

A data wire including the driving source electrode 176 and the driving drain electrode 177 is formed on the interlayer insulating layer 160. Further, the data wire further includes the data line 171, the common power supply line 172, the second storage plate 178, and other wires. In addition, the driving source electrode 176 and the driving drain electrode 177 are connected with the source region 136 and the drain region 137 of the driving semiconductor layer 132 through the through-holes formed on the interlayer insulating layer 160 and the gate insulating layer 140, respectively.

As such, the driving thin film transistor 20 is formed, which includes the driving semiconductor layer 132, the driving gate electrode 155, the driving source electrode 176, and the driving drain electrode 177. The configuration of the driving thin film transistor 20 is not limited the above-mentioned example, but may be modified in various known configurations that can easily be implemented by those skilled in the art.

A planarization layer 180 covering the data wires 172, 176, 177, and 178 is formed on the interlayer insulating layer 160. The planarization layer 180 serves to remove a step and planarize the layer in order to increase the luminous efficiency of the organic light emitting diode 70 to be formed thereon. Further, the planarization layer 180 has the electrode contact hole 182 for exposing a part of the drain electrode 177.

The first electrode 710 of the organic light emitting diode 70 is formed on the planarization layer 180. That is, the organic light emitting diode display 100 includes the plurality of first electrodes 710 that are disposed in each of the plurality of pixels. In this case, the plurality of first electrode 710 are disposed spaced apart from each other. The first electrode 710 is connected to the drain electrode 177 through the electrode contact hole 182 of the planarization layer 180.

Further, a pixel defined layer 190 including an opening for exposing the first electrode 710 is formed on the planarization layer 180. That is, the pixel defined layer 190 has a plurality of openings formed in each pixel. In addition, the first electrode 710 is disposed to correspond to the opening of the pixel defined layer 190. The organic emission layer 720 is formed on the first electrode 710 and the second electrode 730 is formed on the organic emission layer 720. As such, the organic light emitting diode 70 is formed, which includes the first electrode 710, the organic emission layer 720, and the second electrode 730.

The organic emission layer 720 is made of a low molecular organic material or a high molecular organic material. Further, the organic emission layer 720 may be formed by a multilayer including at least one of an emission layer, a hole-injection layer (HIL), a hole-transporting layer (HTL), an electron-transporting layer (ETL), and an electron-injection layer (EIL). In the case in which the multilayer includes all of them, the hole injection layer is disposed on the positive first electrode 710, and the hole transporting layer, the emission layer, the electron transporting layer, and the electron injection layer are laminated thereon in sequence.

Each of the first electrode 710 and the second electrode 730 may be made of a transparent conductive material or a semi-transparent or reflective conductive material. The organic light emitting diode display 100 may be a top emission type, a bottom emission type, or a double-sided emission type according to the kind of the material of which the first electrode 710 and the second electrode 730 are made.

A capsulation substrate 210 is disposed on the second electrode 730 to face the display substrate 110. The encapsulation substrate 210 as a substrate which encapsulates at least a display area DA on the display substrate 110 where an organic light emitting diode is formed is made of a transparent material such as glass, or plastic in the case of the top emission type or the double-sided emission type and an opaque material such as metal in the case of the bottom emission type. The encapsulation substrate 210 has a plate shape.

In the above description, the organic emission layer 720 includes a red organic emission layer 720R, a green organic emission layer 720G, and a blue organic emission layer 720B.

When a peak wavelength of a red emission spectrum of the red organic emission layer is defined as λpr and a spectrum width (FWHM) is defined as Wr, the peak wavelength λpr of the red emission spectrum of the red organic emission layer satisfying the NTSC standard is shown in Equation 1.

λpr≧3.93557E−03Wr²+1.07200E−01Wr+6.10199E+02

λpr≧610 nm (Equation 1)

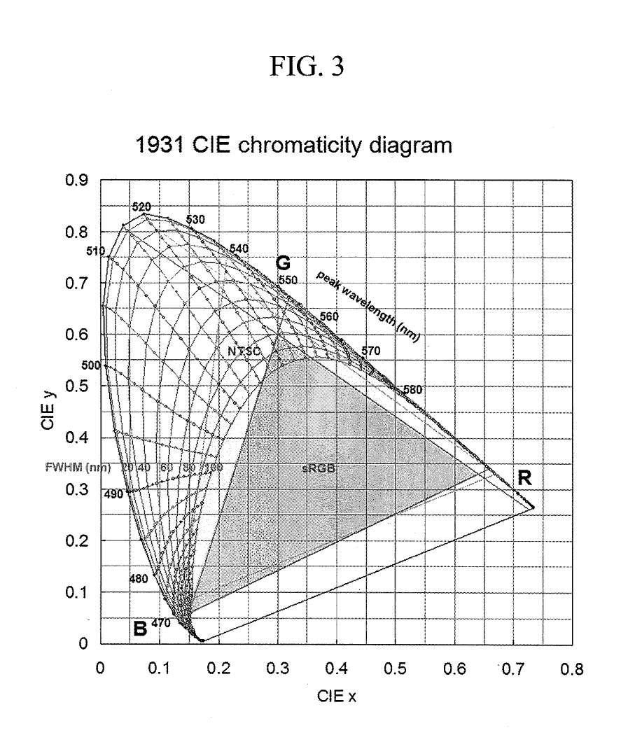

Hereinafter, Equation 1 will be described in detail with reference to FIGS. 3 to 5.

FIG. 3 is a CIE 1931 chromaticity chart showing the relationship between a peak wavelength and a spectrum width of an emission spectrum of an organic light emitting diode display according to a first exemplary embodiment.

In FIG. 3, the CIE 1931 color chart showing a triangle indicating standard chromaticity ranges of the NTSC standard and the sRGB standard is shown.

In FIG. 3, in order for the chromaticity range of the organic emission layer to satisfy the standard chromaticity of the NTSC standard or the sRGB standard, an actual emission color coordinate should be positioned in a region surrounded by two among three straight lines generated subsequent to two standard colors and a curve of an outer periphery corresponding to single wavelength in each standard.

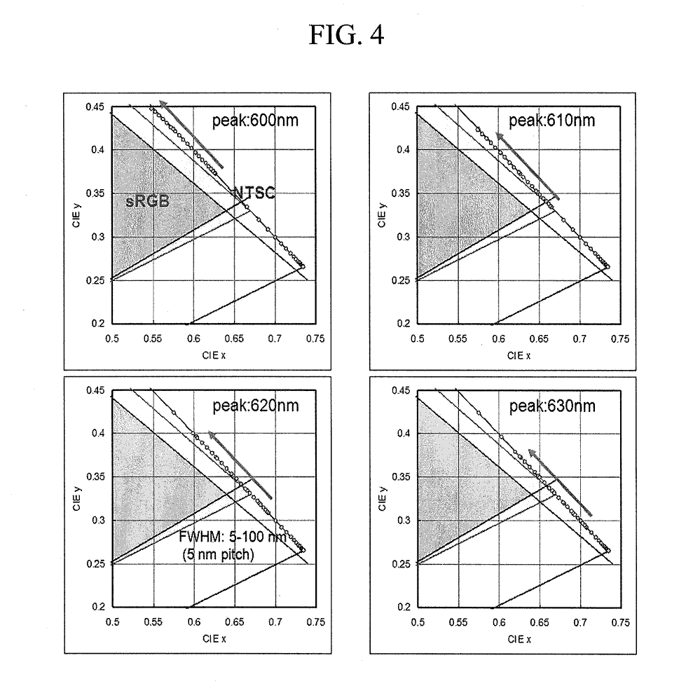

FIG. 4 is a CIE 1931 chromaticity chart enlarging and showing the relationship between a peak wavelength and a spectrum width of a red emission spectrum of an organic light emitting diode display according to a first exemplary embodiment.

In FIG. 4, when the spectrum width is changed from 5 nm to 100 nm at intervals of 5 nm with respect to a case when the peak wavelength of the red emission spectrum is 600 nm, 610 nm, 620 nm, and 630 nm, a red color coordinate is changed.

As shown in FIG. 4, the red color coordinate moves on a line linking a single wavelength when the peak wavelength or the width of the red emission spectrum is changed. That is, as the spectrum width increases, the red color coordinate moves in an arrow direction.

In Table 1, a peak wavelength at which the red color coordinate is the closest to a red color of the NTSC standard is shown and in Table 2, a peak wavelength at which when a straight line linking a blue color and a red color of the sRGB standard extends to the red color, the peak wavelength is the closest to a point where the extended line intersects with a curve connecting a single wavelength color coordinate.

TABLE 1
NTSC

| FWHM | peak | | | efficiency |
|---|---|---|---|---|
| (nm) | (nm) | CIEx | CIEy | (cd/A) |
| 5 | 611.48 | 0.6699 | 0.3299 | 213.94 |
| 10 | 611.91 | 0.6698 | 0.3299 | 211.39 |
| 15 | 612.65 | 0.6698 | 0.3299 | 206.95 |
| 20 | 613.68 | 0.6698 | 0.3299 | 200.87 |
| 25 | 614.99 | 0.6699 | 0.3299 | 193.43 |
| 30 | 616.55 | 0.6698 | 0.3299 | 185.00 |
| 35 | 618.39 | 0.6698 | 0.3299 | 175.66 |
| 40 | 620.46 | 0.6698 | 0.3299 | 165.79 |
| 45 | 622.78 | 0.6699 | 0.3299 | 155.54 |
| 50 | 625.32 | 0.6698 | 0.3299 | 145.22 |
| 55 | 628.05 | 0.6698 | 0.3299 | 135.02 |
| 60 | 630.99 | 0.6698 | 0.3299 | 125.00 |
| 65 | 634.10 | 0.6698 | 0.3299 | 115.38 |
| 70 | 637.38 | 0.6698 | 0.3299 | 106.18 |
| 75 | 640.80 | 0.6698 | 0.3299 | 97.52 |
| 80 | 644.36 | 0.6698 | 0.3299 | 89.39 |
| 85 | 648.02 | 0.6698 | 0.3299 | 81.88 |
| 90 | 651.78 | 0.6698 | 0.3299 | 74.95 |
| 95 | 655.65 | 0.6698 | 0.3299 | 68.53 |
| 100 | 659.59 | 0.6698 | 0.3299 | 62.69 |

TABLE 2
sRGB
R-G extended

| FWHM | peak | | | efficiency |
|---|---|---|---|---|
| (nm) | (nm) | CIEx | CIEy | (cd/A) |
| 5 | 608.13 | 0.6592 | 0.3406 | 233.83 |
| 10 | 608.52 | 0.6592 | 0.3406 | 231.39 |
| 15 | 609.16 | 0.6591 | 0.3406 | 227.37 |
| 20 | 610.07 | 0.6592 | 0.3406 | 221.74 |
| 25 | 611.22 | 0.6592 | 0.3406 | 214.73 |
| 30 | 612.62 | 0.6592 | 0.3406 | 206.58 |
| 35 | 614.26 | 0.6592 | 0.3405 | 197.52 |
| 40 | 616.13 | 0.6592 | 0.3406 | 187.80 |
| 45 | 618.21 | 0.6592 | 0.3406 | 177.63 |
| 50 | 620.51 | 0.6592 | 0.3406 | 167.22 |
| 55 | 623.00 | 0.6592 | 0.3406 | 156.78 |
| 60 | 625.68 | 0.6592 | 0.3406 | 146.47 |
| 65 | 628.53 | 0.6591 | 0.3405 | 136.40 |
| 70 | 631.54 | 0.6592 | 0.3405 | 126.69 |
| 75 | 634.69 | 0.6591 | 0.3405 | 117.43 |
| 80 | 637.96 | 0.6591 | 0.3406 | 108.69 |
| 85 | 641.36 | 0.6591 | 0.3405 | 100.44 |
| 90 | 644.85 | 0.6591 | 0.3406 | 92.76 |
| 95 | 648.45 | 0.6591 | 0.3405 | 85.60 |
| 100 | 652.14 | 0.6591 | 0.3405 | 78.93 |

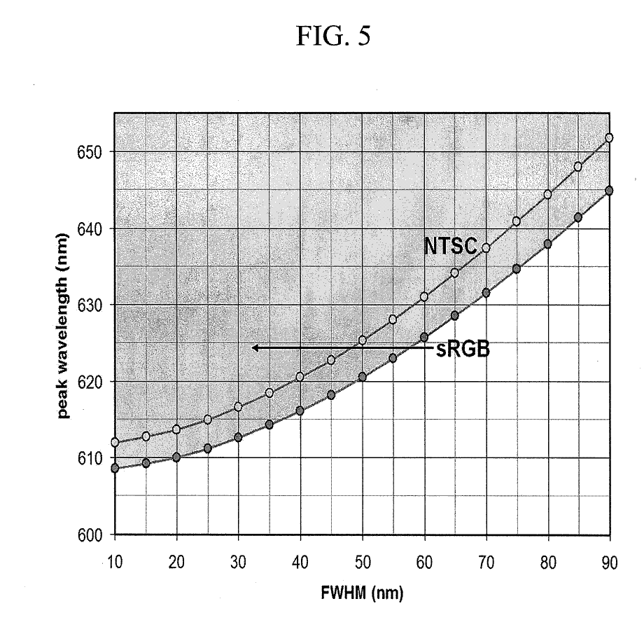

FIG. 5 is a graph illustrating the relationship between a peak wavelength and a spectrum width of a red emission spectrum in the NTSC standard and the sRGB standard shown in Tables 1 and 2.

In FIG. 5, ranges of a peak wavelength and a spectrum width which can maximally enlarge a chromaticity range while satisfying a red standard chromaticity range are shown.

As shown in FIG. 5, an NTSC wavelength boundary line and a region having a small spectrum width, at the left side of the NTSC wavelength boundary line is the red chromaticity range satisfying the NTSC standard and an sRGB wavelength boundary line and a region having a small spectrum width, at the left side of the sRGB wavelength boundary line is the red chromaticity range satisfying the sRGB standard.

In addition, the NTSC wavelength boundary line for the relationship between the peak wavelength and the spectrum width may be presented by using an approximation formula of Equation 2 shown below.

λpr=C(4)Wr⁴+C(3)Wr³+C(2)Wr²+C(1)Wr+C(0) (Equation 2)

Herein, C(0) to C(4) represent coefficients, and coefficients and correlation coefficients for a quartic approximation formula, a cubic approximation formula, and a quadratic approximation formula are shown in Table 3 shown below.

TABLE 3

| | Quartic | Cubic | Quadratic |
|---|---|---|---|
| | approximation | approximation | approximation |
| | formula | formula | formula |
| C (4) | −2.83354E−08 | | |
| C (3) | −1.25504E−05 | −1.85009E−05 | |
| C (2) | 6.44091E−03 | 6.84945E−03 | 3.93557E−03 |
| C (1) | −8.09490E−03 | −1.81894E−02 | 1.07200E−01 |
| C (0) | 6.11363E+02 | 6.11428E+02 | 6.10199E+02 |
| Correlation | 1.00000E+00 | 9.99999E−01 | 9.99494E−01 |
| coefficient | | | |

As shown in Table 3, when the degree of the approximation formula increases, a matching degree between the NTSC wavelength boundary line and the approximation formula increases, but the quadratic approximation formula also excellently represents the NTSC wavelength boundary line of FIG. 5.

As such, by forming the red organic emission layer in which the peak wavelength of the emission spectrum is positioned in a region having a longer wavelength than 610 nm and the red organic emission layer satisfying the condition of Equation 1 in which the relationship between the peak wavelength and the spectrum width of the emission spectrum is expressed by the quadratic approximation formula, the red chromaticity range of the organic light emitting diode display satisfies the NTSC standard, thereby improving color reproduction.

Meanwhile, although the organic light emitting diode display according to the first exemplary embodiment satisfies the NSTC standard, the organic light emitting diode display may be formed to satisfy the sRGB standard.

A coefficient and a correlation coefficient for each of the quartic approximation formula, the cubic approximation formula, and the quadratic formula of the sRGB wavelength boundary line with respect to the relationship between the peak wavelength and the spectrum width is shown in Table 4.

TABLE 4

| | Quartic | Cubic | Quadratic |
|---|---|---|---|
| | approximation | approximation | approximation |
| | formula | formula | formula |
| C (4) | −3.64427E−08 | | |
| C (3) | −7.83235E−05 | −1.54853E−05 | |
| C (2) | 5.63955E−03 | 6.16497E−03 | 3.72604E−03 |
| C (1) | −8.38452E−03 | −2.13672E−02 | 8.35845E−01 |
| C (0) | 6.08042E+02 | 6.08125E+02 | 6.07097E+02 |
| Correlation | 1.00000E+00 | 9.99998E−01 | 9.99574E−01 |
| coefficient | | | |

As shown in Table 4, when the degree of the approximation formula is high, the degree in which sRGB wavelength boundary line and the approximation formula coincide with each other is high, but the quadratic approximation formula also excellently represents the sRGB wavelength boundary line of FIG. 5.

Therefore, the peak wavelength (λpr) of the red emission spectrum of the red organic emission layer that satisfies the sRGB standard is shown in Equation 3.

λpr≧3.72604E−03Wr²+8.35845E−01Wr+6.07097E+02

λpr≧605 nm (Equation 3)

As such, by forming the red organic emission layer in which the peak wavelength of the emission spectrum is positioned in a region having a longer wavelength than 605 nm and the red organic emission layer satisfying the condition of Equation 3 in which the relationship between the peak wavelength and the spectrum width of the emission spectrum is expressed by the quadratic approximation formula, the red chromaticity range of the organic light emitting diode display satisfies the sRGB standard, thereby improving color reproduction.

Meanwhile, assuming that a light emitting surface is a full scattering surface (Lambertian), the luminous efficiency of the organic light emitting diode display is defined as a value acquired by multiplying 1/p by the sum of luminous flux (LF) at each wavelength (λ) and the unit is cd/A.

The luminous flux (LF) at each wavelength (λ) is acquired by Equation 4.

LF=(1/e)×(hc/λ)×[I(λ)/Σ{I(λ)}]×683 K(λ) (Equation 4)

Herein, e represents an electric charge value of an electron, h represents the Planck constant, c represents luminous flux, I(λ) as the number of photons at the wavelength (λ) is experimentally acquired as the emission spectrum, Σ{I(λ)} as the total photon number is experimentally acquired by the entire area of the emission spectrum, and K(λ) represents a value of a visibility function at the wavelength (λ) which is specified in the CIE 1931 chromaticity chart.

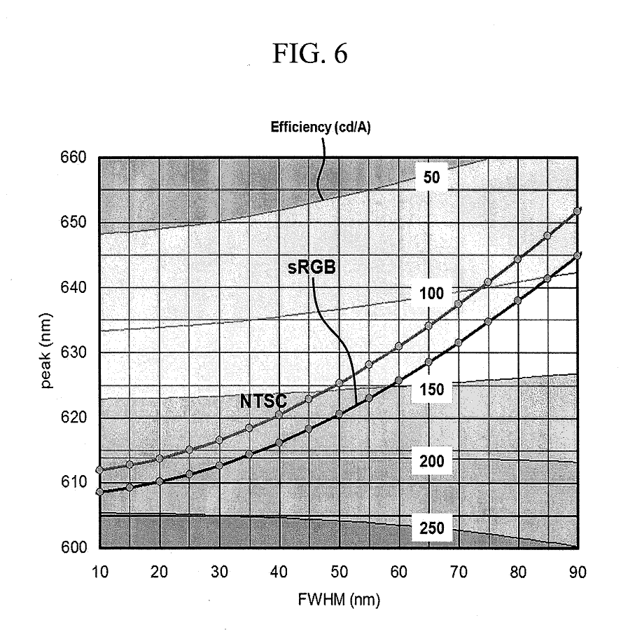

FIG. 6 is a graph representing a contour figure of luminous efficiency (N) in the graph of FIG. 5.

As shown in FIG. 6, the luminous efficiency of the organic light emitting diode display according to the exemplary embodiment increases as the peak wavelength becomes short, but is only slightly dependent on the spectrum width. However, since the NTSC wavelength boundary line and the sRGB wavelength boundary line cross from the lower-left side to the upper-right side of FIG. 6, it is preferable to decrease the spectrum width in order to maximize the luminous efficiency. This may decrease the spectrum width by using an optical microresonator structure, and the like.

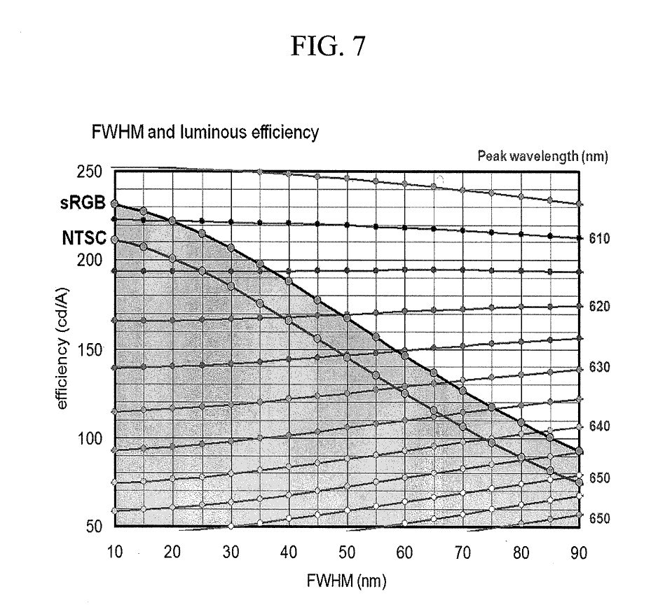

FIG. 7 is a graph showing the relationship between a spectrum width and a peak wavelength of an emission spectrum and luminous efficiency of an organic light emitting diode display according to a first exemplary embodiment.

As shown in FIG. 7, an NTSC efficiency boundary line and a region having a small spectrum width at the left side of the NTSC efficiency boundary line is the range of the spectrum width and the peak wavelength which can maximize luminous efficiency while satisfying the NTSC standard and an sRGB efficiency boundary line and a region having a small spectrum width at the left side of the sRGB efficiency boundary line is the range of the spectrum width and the peak wavelength which can maximize luminous efficiency while satisfying the sRGB standard. For example, in order to make the luminous efficiency larger than 150 cd/A, the peak wavelength should be narrower than 635 nm and the spectrum width should be narrower than 60 nm.

In addition, the NTSC efficiency boundary line for the relationship between the peak wavelength and the spectrum width and the luminous efficiency may be presented by using an approximation formula of Equation 5 shown below.

N=C(4)Wr⁴+C(3)Wr³+C(2)Wr²+C(1)Wr+C(0) (Equation 5)

Herein, C(0) to C(4) represent coefficients, and coefficients and correlation coefficients for a quartic approximation formula, a cubic approximation formula, and a quadratic approximation formula are shown in Table 5 shown below.

TABLE 5

| | Quartic | Cubic | Quadratic |
|---|---|---|---|
| | approximation | approximation | approximation |
| | formula | formula | formula |
| C (4) | −1.66646E−06 | | |
| C (3) | 5.50783E−04 | 2.00825E−04 | |
| C (2) | −5.62566E−02 | −3.22298E−02 | −5.99825E−04 |
| C (1) | 2.73244E−01 | −3.20433E−01 | −3.22298E−02 |
| C (0) | 2.13817E+02 | 2.17611E+02 | 2.30949E+02 |
| Correlation | 9.99999E−01 | 9.99770E−01 | 9.99494E−01 |
| coefficient | | | |

As shown in Table 5, when the degree of the approximation formula increases, a matching degree between the NTSC efficiency boundary line and the approximation formula increases, but the cubic approximation formula also excellently represents the NTSC efficiency boundary line of FIG. 7.

Therefore, the maximum value of the luminous efficiency (N) of the organic light emitting diode display satisfying the NTSC standard is shown in Equation 6.

N≦2.00825E−04Wr³−3.22298E−02Wr²−3.20433E−01Wr+2.17611E+02 (Equation 6)

As such, by forming the red organic emission layer satisfying the condition of Equation 6 that expresses the relationship between the peak wavelength and the spectrum width of the emission spectrum and the luminous efficiency as the cubic approximation formula, the red chromaticity range of the organic light emitting diode display satisfies the NTSC standard so as to improve color reproducibility and improve the luminous efficiency of the organic light emitting diode display.

Meanwhile, in the above description, the organic light emitting diode display according to the first exemplary embodiment which can maximize the luminous efficiency while satisfying the NTSC standard has been described, but the organic light emitting diode display may maximize the luminous efficiency while satisfying the sRGB standard.

A coefficient and a correlation coefficient for each of the quartic approximation formula, the cubic approximation formula, and the quadratic approximation formula of the sRGB efficiency boundary line with respect to the relationship between the peak wavelength and the spectrum width of the emission spectrum and the luminous efficiency is shown in Table 6.

TABLE 6

| | Quartic | Cubic | Quadratic |
|---|---|---|---|
| | approximation | approximation | approximation |
| | formula | formula | formula |
| C (4) | −1.35774E−06 | | |
| C (3) | 4.85767E−04 | 2.00641E−04 | |
| C (2) | −5.35263E−02 | −3.39506E−02 | −2.34965E−03 |
| C (1) | 3.09335E−01 | −1.74361E−01 | −1.53420E+00 |
| C (0) | 2.33358E+02 | 2.36449E+02 | 2.49774E+02 |
| Correlation | 9.99996E−01 | 9.99850E−01 | 9.94621E−01 |
| coefficient | | | |

As shown in Table 6, when the degree of the approximation formula increases, a matching degree between the sRGB efficiency boundary line and the approximation formula increases, but the cubic approximation formula also excellently represents the sRGB efficiency boundary line of FIG. 7.

Therefore, the maximum value of the luminous efficiency (N) of the organic light emitting diode display satisfying the sRGB standard is shown in Equation 7.

N≦2.00641E−04Wr³−3.39506E−02Wr²−1.74361E−01Wr+2.36449E+02 (Equation 7)

As such, by forming the red organic emission layer satisfying the condition of Equation 7 that expresses the relationship between the peak wavelength and the spectrum width of the emission spectrum and the luminous efficiency as the cubic approximation formula, the red chromaticity range of the organic light emitting diode display satisfies the sRGB standard so as to improve color reproducibility and improve the luminous efficiency of the organic light emitting diode display.

A method of manufacturing the organic light emitting diode display according to the first exemplary embodiment will now be described in detail.

First, an organic substrate 111 made of ITO, on which a first electrode 710 is formed is ultrasonic-cleaned for 15 minutes by using each of acetone, isopropyl alcohol, and pure water and thereafter, is subjected to UV ozone treatment.

Next, the glass substrate 111 is mounted on a substrate holder in a vacuum depositing device and after the degree of vacuum reaches up to 10E−06 Torr, a plurality of organic layers are formed on the glass substrate. An organic material forming each of the organic layers is mounted in each of resistance heating evaporating sources installed in the vacuum depositing device and sequentially forms a film. When both kinds of materials are deposited like an organic emission layer, the materials are mounted on different evaporating sources and the material are deposited by adjusting an amount of current supplied to the evaporating source so as to form a predetermined composition ratio in the film. Evaporation velocity is controlled using a quartz oscillation type film thickness sensor and in the case of evaporating a plurality of materials at substantially the same time, at least independent film thickness sensors of a number corresponding to the kinds of the materials are used and film-forming is performed while controlling the evaporation velocity of each material.

A forming process of the organic layer will be described below.

First, a hole injection layer is formed on the first electrode 710 of the glass substrate 111 by using 4,4′,4″-tris(N-(3-methylphenyl)-N-phenylamino)triphenylamino(m-MTDATA). In this case, the hole injection layer is formed at evaporation velocity of 0.1 nm/s and with a thickness of 60 nm.

Next, a hole transporting layer is formed by using N,N′-bis(a-naphthyl)-N,N′-diphenyl-4,4′-diamine(a-NPD). In this case, the hole transporting layer is formed at evaporation velocity of 0.1 nm/s and with a thickness of 25 nm.

Next, a red organic emission layer is formed with a thickness of 35 nm while controlling the evaporation velocity such that the concentration of a red phosphor light emitting material in a host material is 5 wt %. The evaporation velocity is 0.2 nm/s.

Next, a hole blocking layer is formed by using bis(2-methyl-8-quinolinolate)-4-(phenylphenolato)aluminium(BAlq).

Next, an electron transporting layer is formed by using tris(8-hydroxyquinoline)aluminium(III)(Alq). In this case, the electron transporting layer is formed at evaporation velocity of 0.2 nm/s and with a thickness of 25 nm.

Next, an electron injection layer is formed with a thickness in the range of 1 to 2 nm by using lithiumquinolate (Liq).

Next, a second electrode 730 is formed with a thickness of 20 nm by using aluminium (Al).

The organic light emitting diode display according to the first exemplary embodiment manufactured by such a method forms the red organic emission layer that satisfies the conditions of Equation 1 and 7 expressing the relationship between the peak wavelength and the spectrum width of the emission spectrum and the luminous efficiency to allow the red chromaticity range of the organic light emitting diode display satisfies the NTSC or sRGB standard, thereby improving color reproducibility and improving the luminous efficiency of the organic light emitting diode display.

Meanwhile, in the above description, various inventive aspects and features have been applied to the red organic emission layer, but the inventive aspects and features may be applied to a green organic emission layer.

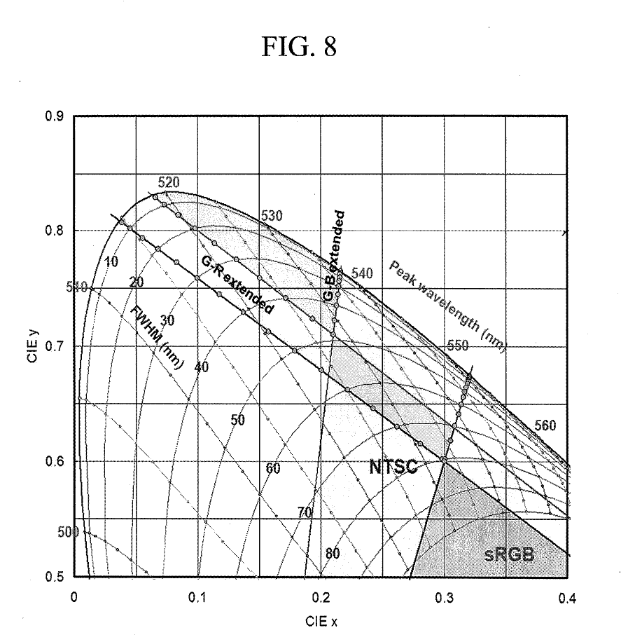

FIG. 8 is a CIE 1931 chromaticity chart enlarging and showing the relationship between a peak wavelength and a spectrum width of a green emission spectrum of an organic light emitting diode display according to a second exemplary embodiment.

The second exemplary embodiment is substantially similar to the first exemplary embodiment shown in FIGS. 4 to 7. One difference occurs in the formation of the green organic emission layer. Therefore, a duplicated description will generally be omitted.

In FIG. 8, in order to extend a chromaticity range without deviating from a standard color in a green part, a color coordinate of a green emission spectrum should exist in a region surrounded by a G-B extended line acquired by extending a straight line that links coordinates of a blue standard color and a green standard color to the green standard color, a G-R extended line acquired by extending a straight line that links color coordinates of a red standard color and the green standard color to the green standard color, and an outer peripheral curve connecting emission at a single wavelength.

In Table 7, a result acquired by calculating a peak wavelength, a color coordinate, and luminous efficiency that exist on the G-B extended and G-R extended straight lines corresponding to the NTSC standard with respect to a spectrum width is shown and in Table 8, a result acquired by calculating a peak wavelength, a color coordinate, and luminous efficiency that exist on the G-B extended and G-R extended straight lines corresponding to the sRGB standard is shown.

TABLE 7
NTSC

| G-B extended | | | | | G-R extended | | | | |
|---|---|---|---|---|---|---|---|---|---|
| FWHM | peak | | | efficiency | FWHM | peak | | | efficiency |
| (nm) | (nm) | CIEx | CIEy | (cd/A) | (nm) | (nm) | CIEx | CIEy | (cd/A) |
| 5 | 538.06 | 0.2161 | 0.7645 | 471.35 | 5 | 518.71 | 0.0660 | 0.8289 | 355.93 |
| 10 | 537.79 | 0.2160 | 0.7636 | 468.92 | 10 | 519.13 | 0.0736 | 0.8227 | 358.33 |
| 15 | 537.35 | 0.2158 | 0.7622 | 464.80 | 15 | 519.73 | 0.0846 | 0.8135 | 361.60 |
| 20 | 536.69 | 0.2155 | 0.7599 | 458.83 | 20 | 520.47 | 0.0983 | 0.8023 | 365.31 |
| 25 | 535.81 | 0.2152 | 0.7565 | 450.85 | 25 | 521.36 | 0.1140 | 0.7893 | 369.31 |
| 30 | 534.67 | 0.2148 | 0.7515 | 440.81 | 30 | 522.40 | 0.1315 | 0.7748 | 373.47 |
| 35 | 533.26 | 0.2138 | 0.7448 | 428.79 | 35 | 523.62 | 0.1507 | 0.7590 | 377.69 |
| 40 | 531.57 | 0.2128 | 0.7352 | 414.97 | 40 | 525.02 | 0.1714 | 0.7418 | 381.71 |
| 45 | 529.58 | 0.2114 | 0.7223 | 399.60 | 45 | 526.62 | 0.1933 | 0.7238 | 385.27 |
| 48.69 | 527.92 | 0.2100 | 0.7100 | 387.39 | 48.69 | 527.92 | 0.2100 | 0.7100 | 387.38 |

TABLE 8
sRGB

| G-B extended | | | | | G-R extended | | | | |
|---|---|---|---|---|---|---|---|---|---|
| FWHM | peak | | | efficiency | FWHM | peak | | | efficiency |
| (nm) | (nm) | CIEx | CIEy | (cd/A) | (nm) | (nm) | CIEx | CIEy | (cd/A) |
| 5 | 552.60 | 0.3207 | 0.6745 | 487.59 | 5 | 514.74 | 0.0391 | 0.8072 | 316.22 |
| 10 | 552.37 | 0.3206 | 0.6742 | 486.36 | 10 | 514.98 | 0.0456 | 0.8020 | 318.62 |
| 15 | 551.99 | 0.3205 | 0.6738 | 484.18 | 15 | 515.35 | 0.0557 | 0.7940 | 321.96 |
| 20 | 551.47 | 0.3203 | 0.6731 | 480.99 | 20 | 515.84 | 0.0684 | 0.7839 | 326.00 |
| 25 | 550.79 | 0.3200 | 0.6722 | 476.70 | 25 | 516.47 | 0.0833 | 0.7722 | 330.66 |
| 30 | 549.98 | 0.3197 | 0.6710 | 471.24 | 30 | 517.25 | 0.0999 | 0.7589 | 335.76 |
| 35 | 549.01 | 0.3193 | 0.6694 | 464.53 | 35 | 518.19 | 0.1180 | 0.7445 | 341.12 |
| 40 | 547.90 | 0.3187 | 0.6673 | 458.57 | 40 | 519.29 | 0.1375 | 0.7291 | 346.46 |
| 45 | 546.63 | 0.3179 | 0.6644 | 447.39 | 45 | 520.55 | 0.1579 | 0.7128 | 351.48 |
| 50 | 545.20 | 0.3168 | 0.6607 | 437.11 | 50 | 521.95 | 0.1790 | 0.6961 | 355.87 |
| 55 | 543.63 | 0.3155 | 0.6557 | 425.86 | 55 | 523.48 | 0.2003 | 0.6792 | 359.38 |
| 60 | 541.90 | 0.3137 | 0.6493 | 413.81 | 60 | 525.14 | 0.2215 | 0.6624 | 361.81 |
| 65 | 540.02 | 0.3114 | 0.6411 | 401.13 | 65 | 526.91 | 0.2421 | 0.6460 | 363.07 |
| 70 | 537.98 | 0.3085 | 0.6306 | 387.96 | 70 | 528.80 | 0.2619 | 0.6303 | 363.10 |
| 75 | 535.77 | 0.3049 | 0.6176 | 374.43 | 75 | 530.78 | 0.2806 | 0.6154 | 361.85 |
| 80 | 533.39 | 0.3006 | 0.6020 | 360.65 | 80 | 532.86 | 0.2981 | 0.6015 | 359.40 |
| 80.60 | 533.10 | 0.3000 | 0.5999 | 359.01 | 80.60 | 533.10 | 0.3000 | 0.5999 | 359.01 |

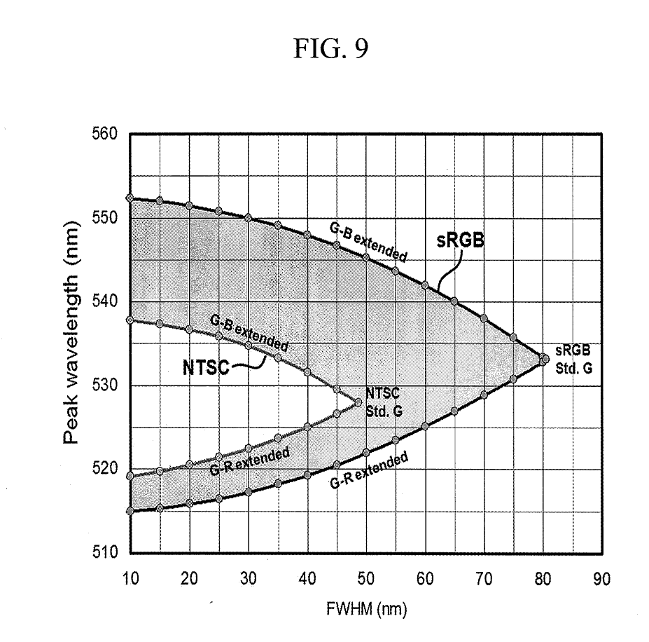

FIG. 9 is a graph illustrating the relationship between a peak wavelength and a spectrum width of a green emission spectrum in the NTSC standard and the sRGB standard shown in Tables 7 and 8.

In FIG. 9, ranges of a peak wavelength and a spectrum width which can maximally enlarge a chromaticity range while satisfying a green standard chromaticity range are shown.

As shown in FIG. 9, an NTSC wavelength boundary line and a region having a small spectrum width, at the left side of the NTSC wavelength boundary line is a green chromaticity range satisfying the NTSC standard and an sRGB wavelength boundary line and a region having a small spectrum width, at the left side of the sRGB wavelength boundary line is a green chromaticity range satisfying the sRGB standard. As the spectrum width decreases, a preferable peak wavelength range is enlarged.

In addition, the NTSC wavelength boundary line for the relationship between the peak wavelength and the spectrum width may be presented by using an approximation formula of Equation 8 shown below.

λpg=C(4)Wg⁴+C(3)Wg³+C(2)Wg²+C(1)Wg+C(0) (Equation 8)

Herein, λpg represents a peak wavelength of the green emission spectrum of the green organic emission layer, Wg represents a spectrum width of the green emission spectrum, and C(0) to C(4) represent coefficients. Coefficients and correlation coefficients for a quartic approximation formula, a cubic approximation formula, and a quadratic approximation formula are shown in Table 9.

TABLE 9

| | Quartic | | Cubic | | Quadratic | |
|---|---|---|---|---|---|---|
| | approximation | | approximation | | approximation | |
| | formula | | formula | | formula | |
| | G-B extended | G-R extended | G-B extended | G-R extended | G-B extended | G-R extended |
| C (4) | 2.45367E−07 | 1.71044E−07 | | | | |
| C (3) | −5.01180E−05 | −6.52781E−06 | −2.38145E−05 | 1.18082E−05 | | |
| C (2) | −2.23532E−03 | 3.04125E−03 | −3.17439E−03 | 2.38663E−03 | −5.09468E−03 | 3.33879E−03 |
| C (1) | −1.12594E−02 | 4.30493E−02 | 1.28781E−03 | 5.17958E−02 | 4.45905E−02 | 3.03246E−02 |
| C (0) | 5.38174E+02 | 5.18410E+02 | 5.38126E+02 | 5.18377E+02 | 5.37887E+02 | 5.18496E+02 |
| Correlation | 1.00000E+00 | 9.99997E−01 | 9.99997E−01 | 9.99998E−01 | 9.99802E−01 | 9.99936E−01 |
| coefficient | | | | | | |

As shown in Table 9, when the degree of the approximation formula increases, a matching degree between the NTSC wavelength boundary line and the approximation formula increases, but the quadratic approximation formula also excellently represents the NTSC wavelength boundary line of FIG. 9.

Therefore, the peak wavelength (λpg) of the green emission spectrum of the green organic emission layer that satisfies the NTSC standard is shown in Equation 9.

3.33879E−03Wg²+3.03246E−02Wg+5.18496E+02≦λpg≦−5.09468E−03Wg²+4.45905E−02Wg+5.37887E+02

515 nm≦λpg≦540 nm

Wg<50 nm (Equation 9)

As such, by forming the green organic emission layer satisfying the condition of Equation 9 expressing the relationship between the peak wavelength and the spectrum width of the emission spectrum as the quadratic approximation formula in a region of which the peak wavelength of the emission spectrum is in the range of 515 nm to 540 nm (more preferably, in the range of 518 nm to 538 nm) and the spectrum width is smaller than 50 nm, the green chromaticity range of the organic light emitting diode display satisfies the NTSC standard, thereby improving color reproducibility.

Meanwhile, although the organic light emitting diode display according to the second exemplary embodiment satisfies the NTSC standard, the organic light emitting diode display may be formed to satisfy the sRGB standard.

A coefficient and a correlation coefficient for each of the quartic approximation formula, the cubic approximation formula, and the quadratic approximation formula of the sRGB wavelength boundary line with respect to the relationship between the peak wavelength and the spectrum width is shown in Table 10.

TABLE 10

| | Quartic | | Cubic | | Quadratic | |
|---|---|---|---|---|---|---|
| | approximation | | approximation | | approximation | |
| | formula | | formula | | formula | |
| | G-B extended | G-R extended | G-B extended | G-R extended | G-B extended | G-R extended |
| C (4) | −1.50802E−08 | −1.54478E−07 | | | | |
| C (3) | 6.97362E−07 | 2.07743E−05 | −1.90868E−06 | −5.92130E−06 | | |
| C (2) | −2.94943E−03 | 2.01204E−03 | −2.80174E−03 | 3.52498E−03 | −3.05147E−03 | 2.75023E−03 |
| C (1) | −1.81896E−03 | 1.29289E−02 | −4.85585E−03 | −1.81801E−02 | 4.10247E−03 | 9.61132E−03 |
| C (0) | 5.52677E+02 | 5.14627E+02 | 5.52694E+02 | 5.14796E+02 | 5.52619E+02 | 5.14566E+02 |
| Correlation | 1.00000E+00 | 9.99998E−01 | 1.00000E+00 | 9.99976E−01 | 9.99991E−01 | 9.99888E−01 |
| coefficient | | | | | | |

As shown in Table 10, when the degree of the approximation formula is high, the degree in which sRGB wavelength boundary line and the approximation formula coincide with each other is high, but the quadratic approximation formula also excellently represents the sRGB wavelength boundary line of FIG. 9.

Therefore, the peak wavelength (λpg) of the green emission spectrum of the green organic emission layer that satisfies the sRGB standard is shown in Equation 10.

2.75023E−03Wg²+9.61132E−03Wg+5.14566E+02≦λpg≦−3.05147E−03Wg²+4.10247E−03Wg+5.52619E+02

510 nm≦λpg≦555 nm

Wb<40 nm (Equation 10)

As such, by forming the green organic emission layer satisfying the condition of Equation 10 expressing the relationship between the peak wavelength and the spectrum width of the emission spectrum as the quadratic approximation formula in a region of which the peak wavelength of the emission spectrum is in the range of 510 nm to 555 nm (more preferably, in the range of 514 nm to 552 nm) and the spectrum width is smaller than 80 nm, the green chromaticity range of the organic light emitting diode display satisfies the sRGB standard, thereby improving color reproducibility.

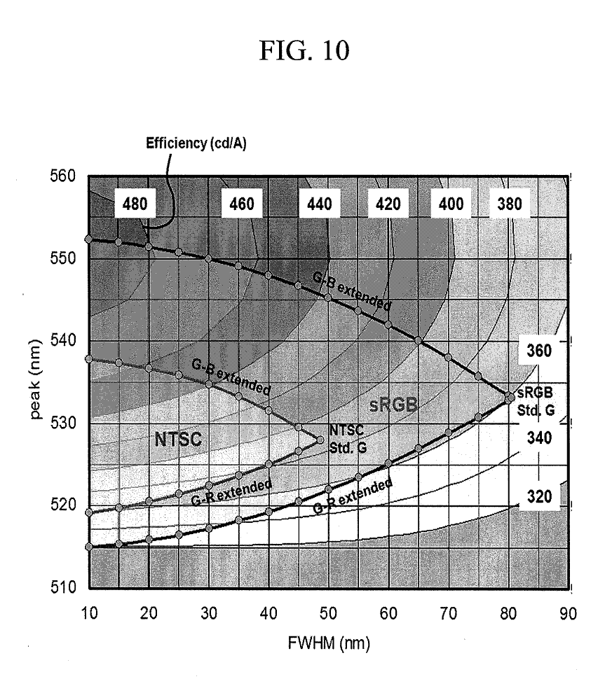

FIG. 10 is a graph representing a contour figure of luminous efficiency (N) in the graph of FIG. 9.

As shown in FIG. 9, the luminous efficiency of the organic light emitting diode display according to the second exemplary embodiment increases as the peak wavelength becomes long, but increases as the spectrum width decreases. Further, since points where the NTSC wavelength boundary line and the sRGB wavelength boundary line meets the contour are different from each other, spectrum conditions for maximizing the luminous efficiency are different from each other.

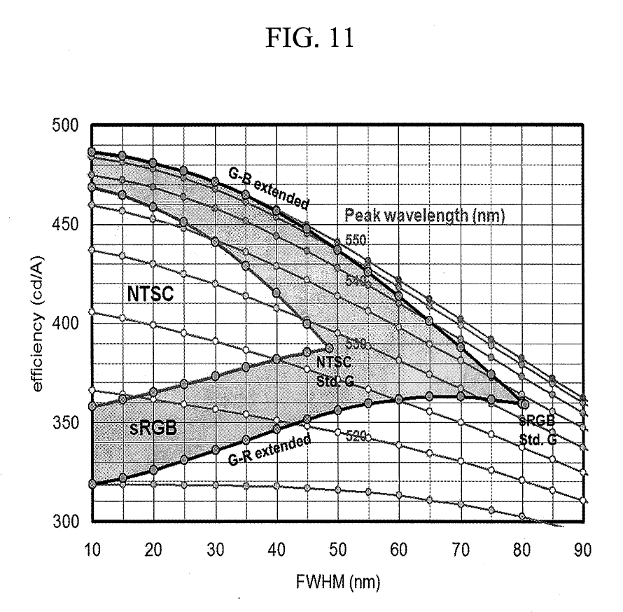

FIG. 11 is a graph showing the relationship between a spectrum width and a peak wavelength of an emission spectrum and luminous efficiency of an organic light emitting diode display according to a second exemplary embodiment.

As shown in FIG. 11, at each peak wavelength, the luminous efficiency increases as the spectrum width decreases and at each peak width, as the peak wavelength is long, the luminous efficiency is high. Therefore, an NTSC efficiency boundary line corresponding to G-B extended and G-R extended lines and a region having a small spectrum width, at the left side of the NTSC efficiency boundary line are ranges of a spectrum width and a peak wavelength which can maximize luminous efficiency while satisfying the NTSC standard and an sRGB efficiency boundary line corresponding to the G-B extended and G-R extended lines and a region having a small spectrum width, at the left side of the sRGB efficiency boundary line are rages of a spectrum width and a peak wavelength which can maximize luminous efficiency while satisfying the sRGB standard. Herein, as the spectrum width decreases, a preferable peak wavelength range is extended and luminous efficiency in each spectrum width is higher as it is closer to the NTSC efficiency boundary line and the sRGB efficiency boundary line corresponding to the G-B extended line.

In addition, the NTSC efficiency boundary line for the relationship between the spectrum width and the peak wavelength and the luminous efficiency may be presented by using the approximation formula of Equation 5 shown above.

Herein, coefficients and correlation coefficients for the quartic approximation formula, the cubic approximation formula, and the quadratic approximation formula are shown in Table 11.

TABLE 11

| | Quartic | | Cubic | | Quadratic | |
|---|---|---|---|---|---|---|
| | approximation | | approximation | | approximation | |
| | formula | | formula | | formula | |
| | G-B extended | G-R extended | G-B extended | G-R extended | G-B extended | G-R extended |
| C (4) | 6.09759E−06 | −1.03453E−06 | | | | |
| C (3) | −5.88568E−04 | −1.43194E−04 | 6.50970E−05 | −2.54095E−04 | | |
| C (2) | −1.95894E−02 | 1.82044E−02 | −4.29261E−02 | 2.21637E−02 | −3.76770E−02 | 1.67474E−03 |
| C (1) | −1.00709E−01 | 2.54798E−01 | 2.11100E−01 | 2.01896E−01 | 9.27327E−02 | 6.63925E−01 |
| C (0) | 4.72410E+02 | 3.54798E+02 | 4.71215E+02 | 3.54395E+02 | 4.71869E+02 | 3.51841E+02 |
| Correlation | 1.00000E+00 | 9.99987E−01 | 9.99977E−01 | 9.99982E−01 | 9.99956E−01 | 9.97749E−01 |
| coefficient | | | | | | |

As shown in Table 11, when the degree of the approximation formula increases, a matching degree between the NTSC efficiency boundary line and the approximation formula increases, but the quadratic approximation formula also excellently represents the NTSC efficiency boundary line of FIG. 11.

Therefore, the maximum value of the luminous efficiency (N) of the organic light emitting diode display satisfying the NTSC standard is shown in Equation 11.

1.67474E−03Wg²+6.63925E−01Wg+3.51841E+02≦N≦−3.76770E−02Wg²+9.27327E−02Wg+4.71869E+02 (Equation 11)

As such, by forming the green organic emission layer satisfying the condition of Equation 11 that expresses the relationship between the peak wavelength and the spectrum width of the emission spectrum and the luminous efficiency as the quadratic approximation formula, the green chromaticity range of the organic light emitting diode display satisfies the NTSC standard so as to improve color reproducibility and improve the luminous efficiency of the organic light emitting diode display.

Meanwhile, in the above description, the organic light emitting diode display according to the second exemplary embodiment which can maximize the luminous efficiency while satisfying the NTSC standard has been described, but the organic light emitting diode display may maximize the luminous efficiency while satisfying the sRGB standard.

A coefficient and a correlation coefficient for each of the quartic approximation formula, the cubic approximation formula, and the quadratic approximation formula of the sRGB efficiency boundary line with respect to the relationship between the peak wavelength and the spectrum width of the emission spectrum and the luminous efficiency is shown in Table 12.

TABLE 12

| | Quartic | | Cubic | | Quadratic | |
|---|---|---|---|---|---|---|
| | approximation | | approximation | | approximation | |
| | formula | | formula | | formula | |
| | G-B extended | G-R extended | G-B extended | G-R extended | G-B extended | G-R extended |
| C (4) | 2.02310E−06 | 1.06343E−06 | | | | |
| C (3) | −2.49979E−04 | −4.64576E−04 | 9.96367E−05 | −2.80803E−04 | | |
| C (2) | −1.27785E−02 | 3.82827E−02 | −3.25926E−02 | 2.78676E−02 | −1.95559E−02 | −8.87324E−03 |
| C (1) | −3.93982E−03 | −9.21898E−02 | 4.03478E−01 | 1.21966E−01 | −6.41644E−02 | 1.43991E+00 |
| C (0) | 4.87916E+02 | 3.15990E+02 | 4.85693E+02 | 3.14821E+02 | 4.89573E+02 | 3.03887E+02 |
| Correlation | 9.99998E−01 | 9.99987E−01 | 9.99922E−01 | 9.99747E−01 | 9.99426E−01 | 9.91905E−01 |
| coefficient | | | | | | |

As shown in Table 12, when the degree of the approximation formula increases, a matching degree between the sRGB efficiency boundary line and the approximation formula increases, but the cubic approximation formula also excellently represents the sRGB efficiency boundary line of FIG. 11.

Therefore, the maximum value of the luminous efficiency (N) of the organic light emitting diode display satisfying the sRGB standard is shown in Equation 12.

1.67474E−03Wg²+6.63925E−01Wg+3.51841E+02≦N≦−3.76770E−02Wg²+9.27327E−02Wg+4.71869E+02 (Equation 12)

As such, by forming the green organic emission layer satisfying the condition of Equation 12 that expresses the relationship between the peak wavelength and the spectrum width of the emission spectrum and the luminous efficiency as the cubic approximation formula, the green chromaticity range of the organic light emitting diode display satisfies the sRGB standard so as to improve color reproducibility and improve the luminous efficiency of the organic light emitting diode display.

A method of manufacturing the organic light emitting diode display according to the second exemplary embodiment is substantially similar to the method of manufacturing the display according to the first exemplary embodiment and is different from the method according to the first exemplary embodiment at least in that the green organic emission layer is made of a green phosphor light emitting material with the thickness of 35 nm while controlling the evaporation velocity such that the concentration of the green phosphor light emitting material in the host material is 5 wt % instead of the red phosphor light emitting material.

Meanwhile, in the above description, various inventive aspects and features have been applied to the red organic emission layer or the green organic emission layer, but the inventive aspects and features may be applied to a blue organic emission layer.

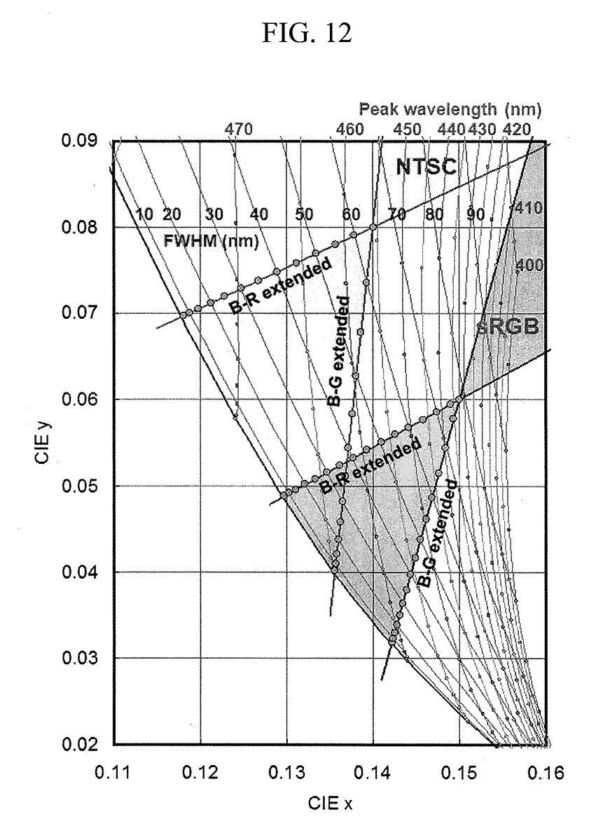

FIG. 12 is a CIE 1931 color chart enlarging and showing the relationship between a peak wavelength and a spectrum width of a blue emission spectrum of an organic light emitting diode display according to a third exemplary embodiment.

The third exemplary embodiment is substantially similar to the first exemplary embodiment shown in FIGS. 4 to 7 except for the formation of the blue organic emission layer. Therefore, a duplicated description will generally be omitted.

In FIG. 12, in order to extend the chromaticity range without deviating from the standard color in a blue part, a color coordinate of a blue emission spectrum should exist in a region surrounded by a B-G extended line acquiring by extending a straight line that links color coordinates of a blue standard color and a green standard color to the blue standard color, a B-R extended line acquired by extending a straight line that links color coordinates of a red standard color and the green standard color to the blue standard color, and an outer peripheral curve connecting emission at a single wavelength.

In Table 13, a result acquired by calculating a peak wavelength, a color coordinate, and luminous efficiency that exist on the B-G extended and B-R extended straight lines corresponding to the NTSC standard with respect to a spectrum width is shown and in Table 14, a result acquired by calculating a peak wavelength, a color coordinate, and luminous efficiency that exist on the B-G extended and B-R extended straight lines corresponding to the sRGB standard is shown.

TABLE 13
NTSC

| B-R extended | | | | | B-G extended | | | | |
|---|---|---|---|---|---|---|---|---|---|
| FWHM | peak | | | efficiency | FWHM | peak | | | efficiency |
| (nm) | (nm) | CIEx | CIEy | (cd/A) | (nm) | (nm) | CIEx | CIEy | (cd/A) |
| 5 | 472.27 | 0.1181 | 0.0697 | 57.57 | 5 | 464.91 | 0.1356 | 0.0401 | 42.95 |
| 10 | 472.12 | 0.1188 | 0.0700 | 58.08 | 10 | 464.74 | 0.1357 | 0.0409 | 43.27 |
| 15 | 471.82 | 0.1198 | 0.0705 | 58.73 | 15 | 464.50 | 0.1358 | 0.0421 | 43.86 |
| 20 | 471.34 | 0.1212 | 0.0712 | 59.55 | 20 | 464.19 | 0.1360 | 0.0438 | 44.75 |
| 25 | 470.67 | 0.1229 | 0.0719 | 60.54 | 25 | 463.79 | 0.1362 | 0.0458 | 45.94 |
| 30 | 469.78 | 0.1247 | 0.0728 | 61.69 | 30 | 463.27 | 0.1365 | 0.0482 | 47.46 |
| 35 | 468.64 | 0.1267 | 0.0738 | 62.91 | 35 | 462.59 | 0.1368 | 0.0511 | 49.29 |
| 40 | 467.24 | 0.1289 | 0.0747 | 64.10 | 40 | 461.74 | 0.1372 | 0.0544 | 51.39 |
| 45 | 465.57 | 0.1311 | 0.0758 | 65.13 | 45 | 460.71 | 0.1376 | 0.0583 | 53.73 |
| 50 | 463.59 | 0.1334 | 0.0769 | 65.84 | 50 | 459.53 | 0.1381 | 0.0627 | 56.25 |
| 55 | 461.29 | 0.1356 | 0.0779 | 66.13 | 55 | 458.25 | 0.1386 | 0.0677 | 58.99 |
| 60 | 458.63 | 0.1379 | 0.0790 | 65.93 | 60 | 456.92 | 0.1393 | 0.0735 | 61.94 |
| 64.84 | 455.66 | 0.1400 | 0.0800 | 65.14 | 64.84 | 455.66 | 0.1400 | 0.0800 | 65.14 |

TABLE 14
sRGB

| B-R extended | | | | | B-G extended | | | | |
|---|---|---|---|---|---|---|---|---|---|
| FWHM | peak | | | efficiency | FWHM | peak | | | efficiency |
| (nm) | (nm) | CIEx | CIEy | (cd/A) | (nm) | (nm) | CIEx | CIEy | (cd/A0 |
| 5 | 467.71 | 0.1297 | 0.0488 | 47.97 | 5 | 461.10 | 0.1422 | 0.0318 | 36.95 |
| 10 | 467.43 | 0.1303 | 0.0491 | 48.15 | 10 | 460.87 | 0.1423 | 0.0323 | 37.05 |
| 15 | 466.95 | 0.1311 | 0.0496 | 48.38 | 15 | 460.47 | 0.1425 | 0.0329 | 37.26 |
| 20 | 466.30 | 0.1321 | 0.0502 | 48.71 | 20 | 459.94 | 0.1428 | 0.0338 | 37.65 |
| 25 | 465.45 | 0.1333 | 0.0508 | 49.13 | 25 | 459.27 | 0.1431 | 0.0350 | 38.22 |
| 30 | 464.37 | 0.1347 | 0.0516 | 49.63 | 30 | 458.38 | 0.1434 | 0.0363 | 38.85 |
| 35 | 463.02 | 0.1361 | 0.0524 | 50.16 | 35 | 457.25 | 0.1439 | 0.0379 | 39.59 |
| 40 | 461.34 | 0.1377 | 0.0532 | 50.57 | 40 | 455.80 | 0.1444 | 0.0397 | 40.29 |
| 45 | 459.29 | 0.1393 | 0.0541 | 50.75 | 45 | 454.02 | 0.1449 | 0.0417 | 40.92 |
| 50 | 456.83 | 0.1409 | 0.0550 | 50.56 | 50 | 451.88 | 0.1455 | 0.0438 | 41.41 |
| 55 | 453.92 | 0.1425 | 0.0559 | 49.92 | 55 | 449.33 | 0.1462 | 0.0461 | 41.63 |
| 60 | 450.49 | 0.1442 | 0.0568 | 48.74 | 60 | 446.39 | 0.1469 | 0.0487 | 41.60 |
| 65 | 446.48 | 0.1458 | 0.0577 | 46.98 | 65 | 443.05 | 0.1476 | 0.0514 | 41.31 |
| 70 | 441.80 | 0.1474 | 0.0585 | 44.63 | 70 | 439.30 | 0.1485 | 0.0544 | 40.78 |
| 75 | 436.30 | 0.1490 | 0.0594 | 41.69 | 75 | 435.15 | 0.1494 | 0.0577 | 40.07 |
| 78.21 | 432.26 | 0.1500 | 0.0600 | 39.53 | 78.21 | 432.26 | 0.1500 | 0.0600 | 39.53 |

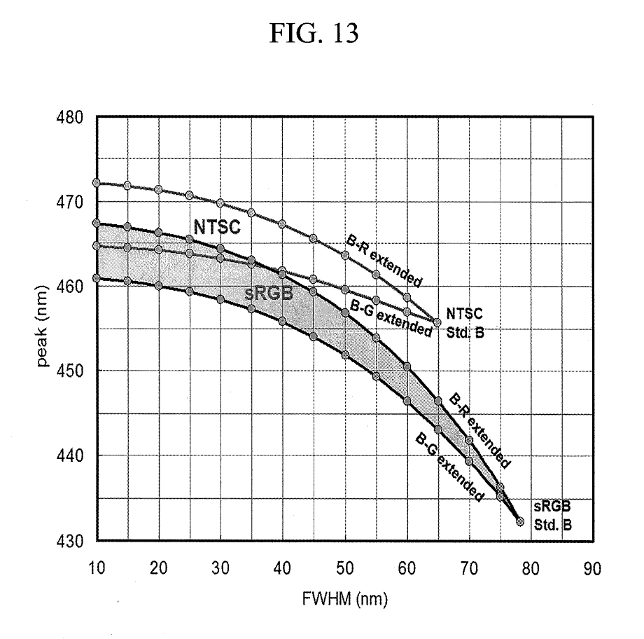

FIG. 13 is a graph illustrating the relationship between a peak wavelength and a spectrum width of a blue emission spectrum in the NTSC standard and the sRGB standard shown in Tables 13 and 14.

In FIG. 13, a peak wavelength and a spectrum width which can maximally extend a chromaticity range while satisfying a blue standard chromaticity range is shown and an upper boundary line corresponds to the B-R extended line and a lower boundary line corresponds to the B-G extended line.

As shown in FIG. 13, an NTSC wavelength boundary line and a region having a small spectrum width, at the left side of the NTSC wavelength boundary line is a blue chromaticity range satisfying the NTSC standard and an sRGB wavelength boundary line and a region having a small spectrum width, at the left side of the sRGB wavelength boundary line is a blue chromaticity range satisfying the sRGB standard.

In each spectrum width, a suitable peak wavelength range is small and as the spectrum width increases, the peak wavelength decreases. For example, when the peak wavelength is approximately in the range of 460 nm to 465 nm, the spectrum width is approximately in the range of 35 nm to 40 nm, and a color coordinate satisfying both the NTSC standard and the sRGB standard exists in a region surrounded by the B-G extended line of the NTSC standard and the B-R extended line of the sRGB standard.

In addition, the NTSC wavelength boundary line for the relationship between the peak wavelength and the spectrum width may be presented by using an approximation formula of Equation 13 shown below.

λpb=C(4)Wb⁴+C(3)Wb³+C(2)Wb²+C(1)Wb+C(0) (Equation 13)

Herein, λpb represents a peak wavelength of the blue emission spectrum of the blue organic emission layer, Wb represents a spectrum width of the blue green emission spectrum, and C(0) to C(4) represent coefficients. Coefficients and correlation coefficients for a quartic approximation formula, a cubic approximation formula, and a quadratic approximation formula are shown in Table 15.

TABLE 15

| | Quartic | | Cubic | | Quadratic | |
|---|---|---|---|---|---|---|
| | approximation | | approximation | | approximation | |
| | formula | | formula | | formula | |
| | B-R extended | B-G extended | B-R extended | B-G extended | B-R extended | B-G extended |
| C (4) | −7.15407E−08 | 8.88484E−07 | | | | |
| C (3) | −1.96446E−05 | −1.23805E−04 | −2.96364E−05 | 2.84882E−07 | | |
| C (2) | −2.59864E−03 | 3.09673E−03 | −2.13811E−03 | 2.62279E−03 | −5.24375E−03 | −2.59294E−03 |
| C (1) | 1.47870E−02 | −7.00418E−02 | 6.98942E−03 | 2.67988E−02 | 9.70218E−02 | 2.59334E−02 |
| C (0) | 4.72254E+02 | 4.65214E+02 | 4.72290E+02 | 4.64765E+02 | 4.71672E+02 | 4.64771E+02 |
| Correlation | 9.99998E−01 | 9.99969E−01 | 9.99997E−01 | 9.99458E−01 | 9.99235E−01 | 9.99458E−01 |
| coefficient | | | | | | |

As shown in Table 15, when the degree of the approximation formula increases, a matching degree between the NTSC wavelength boundary line and the approximation formula increases, but the quadratic approximation formula also excellently represents the NTSC wavelength boundary line of FIG. 13.

Therefore, the peak wavelength (λpb) of the blue emission spectrum of the blue organic emission layer that satisfies the NTSC standard is shown in Equation 14.

−2.59294E−03Wb²+2.59334E−02Wb+4.64771E+02≦pb≦−5.24375E−03Wg²+9.70218E−02Wg+4.71672E+02

450 nm≦λpb≦480 nm

Wb<70 nm (Equation 14)

As such, by forming the blue organic emission layer satisfying the condition of Equation 14 expressing the relationship between the peak wavelength and the spectrum width of the emission spectrum as the quadratic approximation formula in a region of which the peak wavelength of the emission spectrum is in the range of 450 nm to 480 nm and the spectrum width is smaller than 70 nm (more preferably, the peak wavelength of the emission spectrum is in the range of 455 nm to 472 nm and the spectrum width is in a range smaller than 65 nm), the blue chromaticity range of the organic light emitting diode display satisfies the NTSC standard, thereby improving color reproducibility.

Meanwhile, although the organic light emitting diode display according to the third exemplary embodiment satisfies the NTSC standard, the organic light emitting diode display may be formed to satisfy the sRGB standard.

A coefficient and a correlation coefficient for each of the quartic approximation formula, the cubic approximation formula, and the quadratic approximation formula of the sRGB wavelength boundary line with respect to the relationship between the peak wavelength and the spectrum width is shown in Table 16.

TABLE 16

| | Quartic | | Cubic | | Quadratic | |
|---|---|---|---|---|---|---|
| | approximation | | approximation | | approximation | |
| | formula | | formula | | formula | |
| | B-R extended | B-G extended | B-R extended | B-G extended | B-R extended | B-G extended |
| C (4) | −4.42855E−07 | 3.52962E−07 | | | | |
| C (3) | 5.39957E−06 | −9.56159E−05 | −6.83799E−05 | −3.68126E−05 | | |
| C (2) | −3.47099E−03 | 1.40374E−03 | 5.65420E−04 | −1.81334E−03 | −8.01964E−03 | −6.43513E−03 |
| C (1) | −3.71254E−03 | −6.69941E−02 | −8.40121E−02 | −2.99417E−03 | 2.12095E−01 | 1.56416E−01 |
| C (0) | 4.67806E+02 | 4.61444E+02 | 4.68232E+02 | 4.61104E+02 | 4.65859E+02 | 4.59826E+02 |
| Correlation | 9.99996E−01 | 9.99995E−01 | 9.99954E−01 | 9.99956E−01 | 9.97085E−01 | 9.98745E−01 |
| coefficient | | | | | | |

As shown in Table 16, when the degree of the approximation formula is high, the degree in which sRGB wavelength boundary line and the approximation formula coincide with each other is high, but the quadratic approximation formula also excellently represents the sRGB wavelength boundary line of FIG. 13.

Therefore, the peak wavelength (λpb) of the blue emission spectrum of the blue organic emission layer that satisfies the sRGB standard is shown in Equation 15.

−3.68126E−05Wb³−1.81334E−03Wb²−2.99417E−03Wb+4.61104E+02≦λpb≦−6.83799E−05Wb³+5.65420E−04Wb²−8.40121E−02Wb+4.68232E+02

430 nm≦λpb≦470 nm

Wb<80 nm (Equation 15)

As such, by forming the blue organic emission satisfying the condition of Equation 15 expressing the relationship between the peak wavelength and the spectrum width of the emission spectrum as the quadratic approximation formula in a region of which the peak wavelength of the emission spectrum is in the range of 450 nm to 480 nm and the spectrum width is in a range smaller than 78 nm), the blue chromaticity range of the organic light emitting diode display satisfies the sRGB standard, thereby improving color reproducibility.

Further, a color coordinate satisfying both the NTSC standard and the sRGB standard exists in a region surrounded by a part corresponding to the B-G extended line in the NTSC wavelength boundary line and a part corresponding to the B-R extended line in the sRGB wavelength boundary line in a region in which the peak wavelength of the emission spectrum is in the range of 460 nm to 470 nm (more preferably, the peak wavelength is in the range of 460 nm to 467 nm) and the spectrum width is smaller than 40 nm.

A part corresponding to the B-G extended line in the NTSC wavelength boundary line and a part corresponding to the B-R extended line in the sRGB wavelength boundary line may be represented by using the approximation formula of Equation 13 and coefficients and correlation coefficients for a quartic approximation formula, a cubic approximation formula, and a quadratic approximation formula are shown in Tables 15 and 16.

A peak wavelength (λpb) of the blue emission spectrum of the blue organic emission layer satisfying the NTSC standard and the sRGB standard is shown in Equation 16.

−2.59294E−03Wb²+2.59334E−02Wb+4.64771E+02≦pb≦−6.83799E−05Wb³+5.65420E−04Wb²−8.40121E−02Wb+4.68232E+02

460 nm≦λpb≦470 nm

Wb<40 nm (Equation 16)

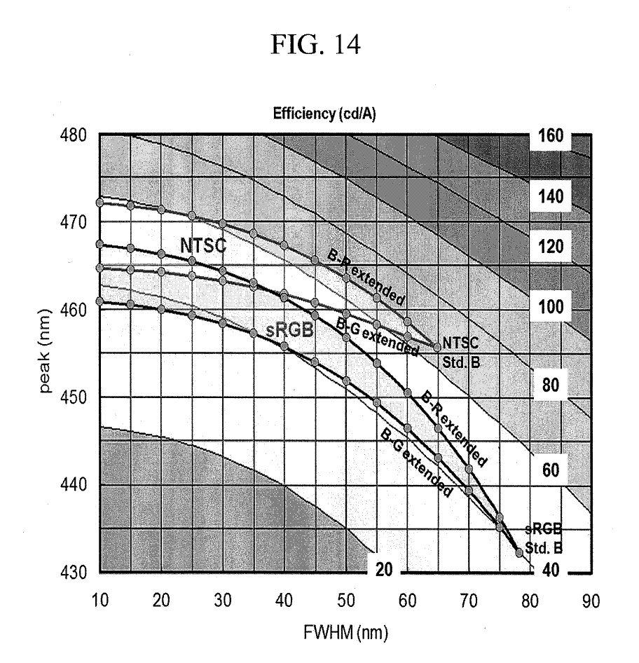

FIG. 14 is a graph representing a contour figure of luminous efficiency (N) in the graph of FIG. 13.

As shown in FIG. 14, the luminous efficiency of the organic light emitting diode display according to the third exemplary embodiment is little dependent on a change of the spectrum width and the range of the peak wavelength for maximizing the luminous efficiency is narrow as 10 nm.

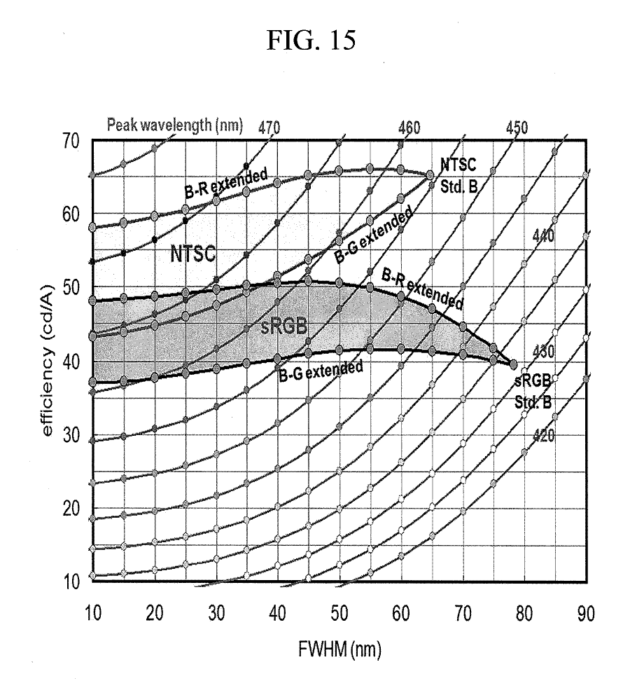

FIG. 15 is a graph illustrating a relationship between a spectrum width and a peak wavelength of an emission spectrum and luminous efficiency of the organic light emitting diode display according to the third exemplary embodiment.

As shown in FIG. 15, in each peak wavelength, the luminous efficiency decreases as the spectrum width decreases and in each spectrum width, the luminous efficiency is high as the peak wavelength increases. Therefore, an NTSC efficiency boundary line corresponding to B-G extended and B-R extended lines and a region having a small spectrum width, at the left side of the NTSC efficiency boundary line are ranges of a spectrum width and a peak wavelength which can maximize luminous efficiency while satisfying the NTSC standard and an sRGB efficiency boundary line corresponding to the B-G extended and B-R extended lines and a region having a small spectrum width, at the left side of the sRGB efficiency boundary line are rages of a spectrum width and a peak wavelength which can maximize luminous efficiency while satisfying the sRGB standard. Herein, the luminous efficiency in each spectrum width is higher as it is closer to the NTSC efficiency boundary line and the sRGB efficiency boundary line corresponding to the B-R extended line. In order to maximize the luminous efficiency, it is preferably that the peak wavelength increases and the spectrum width decreases or the peak wavelength decreases and the spectrum width increases.

In addition, the NTSC efficiency boundary line for the relationship between the spectrum width and the peak wavelength and the luminous efficiency may be presented by using the approximation formula of Equation 5 shown above.

Herein, coefficients and correlation coefficients for the quartic approximation formula, the cubic approximation formula, and the quadratic approximation formula are shown in Table 17.

TABLE 17

| | Quartic | | Cubic | | Quadratic | |
|---|---|---|---|---|---|---|
| | approximation | | approximation | | approximation | |
| | formula | | formula | | formula | |
| | B-R extended | B-G extended | B-R extended | B-G extended | B-R extended | B-G extended |
| C (4) | −1.11677E−06 | 5.11866E−08 | | | | |
| C (3) | 3.12642E−05 | −2.52908E−05 | −1.24710E−04 | −1.81418E−05 | | |
| C (2) | 4.16967E−03 | 7.55776E−03 | 1.13588E−02 | 7.22825E−03 | −1.70981E−03 | 5.32714E−03 |
| C (1) | 2.17252E−02 | −5.81238E−02 | −9.99978E−02 | −5.25447E−02 | 2.78859E−01 | 2.56826E−03 |
| C (0) | 5.73824E+01 | 4.30855E+01 | 5.79470E+01 | 4.30597E+01 | 5.53432E+01 | 4.26809E+01 |
| Correlation | 9.99855E−01 | 9.99977E−01 | 9.99087E−01 | 9.99946E−01 | 9.59379E−01 | 9.99822E−01 |
| coefficient | | | | | | |

As shown in Table 17, when the degree of the approximation formula increases, a matching degree between the NTSC efficiency boundary line and the approximation formula increases, but the cubic approximation formula also excellently represents the NTSC efficiency boundary line of FIG. 15.

Therefore, the maximum value of the luminous efficiency (N) of the organic light emitting diode display satisfying the NTSC standard is shown in Equation 17.

−1.81418E−05Wb³+7.22825E−03Wb²−5.25447E−02Wb+4.30597E+01≦N≦−1.24710E−04Wb³+1.13588E−02Wb²−9.99978E−02Wb+5.79470E+01 (Equation 17)

As such, by forming the blue organic emission layer satisfying the condition of Equation 17 that expresses the relationship between the peak wavelength and the spectrum width of the emission spectrum and the luminous efficiency as the quadratic approximation formula, the blue chromaticity range of the organic light emitting diode display satisfies the NTSC standard so as to improve color reproducibility and improve the luminous efficiency of the organic light emitting diode display.

Meanwhile, in the above description, the organic light emitting diode display according to the third exemplary embodiment which can maximize the luminous efficiency while satisfying the NTSC standard has been described, but the organic light emitting diode display may maximize the luminous efficiency while satisfying the sRGB standard.

A coefficient and a correlation coefficient for each of the quartic approximation formula, the cubic approximation formula, and the quadratic approximation formula of the sRGB efficiency boundary line with respect to the relationship between the peak wavelength and the spectrum width of the emission spectrum and the luminous efficiency is shown in Table 18.

TABLE 18

| | Quartic | | Cubic | | Quadratic | |
|---|---|---|---|---|---|---|
| | approximation | | approximation | | approximation | |
| | formula | | formula | | formula | |
| | B-R extended | B-G extended | B-R extended | B-G extended | B-R extended | B-G extended |
| C (4) | 1.14149E−07 | 4.01744E−07 | | | | |
| C (3) | −1.28995E−04 | −1.30473E−04 | −1.09978E−04 | −6.35427E−05 | | |
| C (2) | 9.62030E−03 | 9.88300E−03 | 8.57988E−03 | 6.22130E−03 | −5.22775E−03 | −1.75646E−03 |
| C (1) | −1.34540E−01 | −1.42275E−01 | −1.13843E−01 | −6.94293E−02 | 3.62397E−01 | 2.05732E−01 |
| C (0) | 4.85370E+01 | 3.75144E+01 | 4.84272E+01 | 3.71279E+01 | 4.46105E+01 | 3.49227E+01 |
| Correlation | 9.99067E−01 | 9.99829E−01 | 9.990.31E−01 | 9.96666E−01 | 9.04020E−01 | 8.81384E−01 |
| coefficient | | | | | | |

As shown in Table 18, when the degree of the approximation formula is high, the degree in which sRGB efficiency boundary line and the approximation formula coincide with each other is high, but the cubic approximation formula also excellently represents the sRGB efficiency boundary line of FIG. 11.

Therefore, the maximum value of the luminous efficiency (N) of the organic light emitting diode display satisfying the sRGB standard is shown in Equation 18.

−6.35427E−05Wb³+6.22130E−03Wb²−6.94293E−02Wb+3.71279E+01≦N≦−1.09978E−04Wb³+8.57988E−03Wb²−1.13843E−01Wb+4.84272E+01 (Equation 18)

As such, by forming the blue organic emission layer satisfying the condition of Equation 18 that expresses the relationship between the peak wavelength and the spectrum width of the emission spectrum and the luminous efficiency as the cubic approximation formula, the blue chromaticity range of the organic light emitting diode display satisfies the sRGB standard so as to improve color reproducibility and improve the luminous efficiency of the organic light emitting diode display.

A method of manufacturing the organic light emitting diode display according to the third exemplary embodiment is substantially similar to the method of manufacturing the display according to the first exemplary embodiment and is different from the method according to the first exemplary embodiment at least in that the blue organic emission layer is formed with the thickness of 35 nm while controlling the evaporation velocity such that the concentration of a blue phosphor light emitting material in the host material instead of the red phosphor light emitting material is 5 wt % and a hole blocking layer is not formed by using bis(2-methyl-8-quinolinolate)-4-(phenylphenolato)aluminium(BAlq).

In the first to third exemplary embodiments, various inventive aspects and features are applied to an organic emission layer corresponding to one color of red, green, and blue colors of the organic light emitting diode display and organic emission layers corresponding to the other colors do not satisfy the NTSC standard or the sRGB standard, but an organic emission layer of one or more colors of the organic light emitting diode display may be formed according to the inventive aspects and features.

The inventive aspects and features can be primarily applied to the organic light emitting diode display and can be applied to self light emitting displays such as a field effect display (FED), a surface conduction type electron emission display (SED), a plasma display panel (PDP), and the like and can also be applied to a liquid crystal display using a cold cathode ray tube or a light emitting diode as a light source.

While this disclosure has been described in connection with what is presently considered to be practical exemplary embodiments, it is to be understood that the invention is not limited to the disclosed embodiments, but, on the contrary, is intended to cover various modifications and equivalent arrangements.

What is claimed is:

1. A display device, comprising:
a substrate;
a plurality of first electrodes formed on the substrate;
a plurality of organic emission layers, each formed on one of the first electrodes, wherein the organic emission layers are each configured to emit light of one of red, green, and blue colors; and
a plurality of second electrodes, each formed on one of the organic emission layers,
wherein a chromaticity range of the red organic emission layer satisfies an NTSC standard if λpr=3.93557E−03 Wr²+1.07200E−01 Wr+6.10199E+02 and λpr=610 nm,
wherein a chromaticity range of the green organic emission layer satisfies the NTSC standard if 3.33879E−03 Wg²+3.03246E−02 Wg+5.18496E+02≦λpg≦−5.09468E−03 Wg²+4.45905E−02 Wg+5.37887E+02, 515 nm≦λpg≦540 nm, and Wg<50 nm,
wherein a chromaticity range of the blue organic emission layer satisfies the NTSC standard if −2.59294E−03 Wb²+2.59334E−02 Wb+4.64771E+02≦λpb≦−5.24375E−03 Wb²+9.70218E−02 Wb+4.71672E+02, 450 nm≦λpb≦480 nm, and Wb<70 nm,
wherein λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and
wherein at least one of the red organic emission layer, the green organic emission layer, and the blue organic emission layer satisfies the NTSC standard.

2. The display device of claim 1, wherein:
luminous efficiency (N) is represented by:
N=2.00825E−04Wr³−3.22298E−02Wr²−3.20433E−01Wr+2.17611E+02.

3. The display device of claim 1, wherein:
luminous efficiency (N) is represented by:
N=1.67474E−03Wg²+6.63925E−01Wg+3.51841E+02=N=−3.76770E−02 Wg²+9.27327E−02Wg+4.71869E+02.

4. The display device of claim 1, wherein:
luminous efficiency (N) is represented by:
−1.81418E−05Wb³+7.22825E−03Wb²−5.25447E−02Wb+4.30597E+01=N=−1.24710E−04Wb³+1.13588E−02Wb²−9.99978E−02Wb+5.79470E+01.

5. A display device, comprising:
a substrate;
a plurality of first electrodes formed on the substrate;
a plurality of organic emission layers, each formed on one of the first electrodes, wherein the organic emission layers are each configured to emit light of one of red, green, and blue colors; and
a plurality of second electrodes, each formed on one of the organic emission layers,
wherein a chromaticity range of the red organic emission layer satisfies an NTSC standard if λpr=3.93557E−03 Wr²+1.07200E−01 Wr+6.10199E+02 and λpr=610 nm,
wherein a chromaticity range of the green organic emission layer satisfies the NTSC standard if 3.33879E−03 Wg²+3.03246E−02 Wg+5.18496E+02≦λpg≦−5.09468E−03 Wg²+4.45905E−02 Wg+5.37887E+02, 515 nm≦λpg≦540 nm, and Wg<50 nm,
wherein a chromaticity range of the blue organic emission layer satisfies the NTSC standard and the sRGB standard if −2.59294E−03 Wb²+2.59334E−02 Wb+4.64771E+02≦λpb≦−6.83799E−05 Wb³+5.65420E−04 Wb²−8.40121E−02 Wb+4.68232E+02, 460 nm≦λpb≦470 nm, and Wb<40 nm,
wherein λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and
wherein at least one of the red organic emission layer, the green organic emission layer, and the blue organic emission layer satisfies the NTSC standard or the NTSC standard and an sRGB standard.

6. A display device, comprising:
a substrate;
a plurality of first electrodes formed on the substrate;
a plurality of organic emission layers, each formed on one of the first electrodes, and
a plurality of second electrodes, each formed on one of the organic emission layers,
wherein a chromaticity range of the red organic emission layer satisfies an sRGB standard if λpr=3.72604E−03 Wr²+8.35845E−01 Wr+6.07097E+02 and λpr=605 nm,
wherein a chromaticity range of the green organic emission layer satisfies the sRGB standard if 2.75023E−03 Wg²+9.61132E−03 Wg+5.14566E+02≦λpg≦−3.05147E−03 Wg²+4.10247E−03 Wg+5.52619E+02, 510 nm≦λpg≦555 nm, and Wg<80 nm,
wherein a chromaticity range of the blue organic emission layer satisfies the sRGB standard if −3.68126E−05 Wb³−1.81334E−03 Wb²−2.99417E−03 Wb+4.61104E+02≦λpb≦−6.83799E−05 Wb³+5.65420E−04 Wb²−8.40121E−02 Wb+4.68232E+02, 430 nm≦pb≦470 nm, and Wb<80 nm,
wherein λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and
wherein at least one of the red organic emission layer, the green organic emission layer, and the blue organic emission layer satisfies the sRGB standard.

7. The display device of claim 6, wherein:
luminous efficiency (N) is represented by:
N=2.00641E−04Wr³−3.39506E−02Wr²−1.74361E−01Wr+2.36449E+02.

8. The display device of claim 6, wherein:
luminous efficiency (N) is represented by:
1.67474E−03Wg²+6.63925E−01Wg+3.51841E+02=N=−3.76770E−02Wg²+9.27327E−02Wg+4.71869E+02.

9. The display device of claim 6, wherein:
luminous efficiency is represented by:
−6.35427E−05Wb³+6.22130E−03Wb²−6.94293E−02Wb+3.71279E+01=N=−1.09978E−04Wb³+8.57988E−03Wb²−1.13843E−01Wb+4.84272E+01.

10. A display device, comprising:
a substrate;
a plurality of first electrodes formed on the substrate;
a plurality of organic emission layers, each formed on one of the first electrodes; and
a plurality of second electrodes, each formed on one of the organic emission layers,
wherein a chromaticity range of the red organic emission layer satisfies an sRGB standard if λpr=3.72604E−03 Wr²+8.35845E−01 Wr+6.07097E+02 and λpr=605 nm,
wherein a chromaticity range of the green organic emission layer satisfies the sRGB standard if 2.75023E−03 Wg²+9.61132E−03 Wg+5.14566E+02≦λpg≦−3.05147E−03 Wg²+4.10247E−03 Wg+5.52619E+02, 510 nm≦λpg≦555 nm, and Wg<80 nm,
wherein a chromaticity range of the blue organic emission layer satisfies the NTSC standard and the sRGB standard if −2.59294E−03 Wb²+2.59334E−02 Wb+4.64771E+02≦λpb≦−6.83799E−05 Wb³+5.65420E−04 Wb²−8.40121E−02 Wb+4.68232E+02, 460 nm≦λpb≦470 nm, and Wb<40 nm,
wherein λpr is a peak wavelength of an emission spectrum of the red organic emission layers, Wr is a spectrum width of the red organic emission layers, λpg is a peak wavelength of an emission spectrum of the green organic emission layer, Wg is a spectrum width of the green organic emission layers, λpb is a peak wavelength of an emission spectrum of the blue organic emission layers, and Wb is a spectrum width of the blue organic emission layers, and
wherein at least one of the red organic emission layer, the green organic emission layer, and the blue organic emission layer satisfies the sRGB standard or the NTSC standard and the sRGB standard.
